(19) United States
(12) Patent Application Publication
(10) Pub. No.: US 2025/0204744 A1
(43) Pub. Date: Jun. 26, 2025

(54) DOOR LOCK DEVICE, ELECTRICAL APPLIANCE AND CONTROL METHOD

(71) Applicant: ILLINOIS TOOL WORKS INC., GLENVIEW, IL (US)

(72) Inventors: Yukun Liu, Dongguan City (CN); Guoshuai Wang, Dongguan City (CN)

(73) Assignee: ILLINOIS TOOL WORKS INC., GLENVIEW, IL (US)

(21) Appl. No.: 18/989,436

(22) Filed: Dec. 20, 2024

(30) Foreign Application Priority Data
Dec. 22, 2023 (CN) 2023117869403
Oct. 25, 2024 (CN) 2024115054366

(51) Int. Cl. A47L 15/46; E05B 65/00

(52) U.S. Cl. CPC A47L 15/46; E05B 65/00; A47L 2401/26; A47L 2401/34; A47L 2501/22; A47L 2501/28

(57) ABSTRACT

A control method for a door lock device, the control method including: determining whether there is an obstacle in a gap with which a door of an electrical apparatus is opened in the process of the door moving toward a closed position; controlling a motor to rotate in a second direction of rotation for a predetermined period of time if there is an obstacle in the gap, and repeating the step until the obstacle is removed from the gap; and controlling the motor to rotate in a first direction of rotation if there is no obstacle in the gap, so as to allow the door to move to the closed position. The control method can prevent an obstacle (for example, a hand of a user accidentally reaching into the gap) from being clamped during an automatic door closing process for a dishwasher.

### CROSS-REFERENCE TO RELATED APPLICATIONS

Chinese Patent Application No. CN 2023117869403, filed on 22 Dec. 2023, and Chinese Patent Application No. CN 2024115054366, filed on 25 Oct. 2024, the priority documents corresponding to this invention; to which a foreign priority benefit is claimed under Title 35, United States Code, Section 119, and their entire teachings are incorporated, by reference, into this specification.

### BACKGROUND OF THE INVENTION

### Field of the Invention

The present disclosure relates to a door lock device of an electrical apparatus, an electrical apparatus and a control method, and in particular to a door lock device capable of automatically opening and closing a door of an electrical apparatus, an electrical apparatus provided with the door lock device, and a control method for controlling automatic opening and closing of the door.

### Discussion of Related Art

A door of an electrical apparatus, such as a dishwasher, is generally provided with a door lock. A conventional door lock can be unlocked by means of physical pulling or locked by means of physical pushing, that is, the door can be unlocked by manually pulling a latch on the door, or the door can be locked by manually bumping a door hook of the door against a door hook hole.

### SUMMARY OF THE INVENTION

After a dishwasher completes a washing operation, it is typically required to further perform a drying operation, and a user expects that a door of the dishwasher can be kept in a partially open state in this case, for example, leaving a gap for allowing sufficient ventilation, such that hot steam is discharged from an internal cavity of the dishwasher, thus facilitating faster drying. During the drying operation, the user typically does not wait beside the dishwasher for the drying operation to be completed.

Therefore, a door lock device may be arranged on one side of the dishwasher facing a door hook of the door, and the door lock device includes a door lock assembly, a driving device and a control device. The door lock device has a door lock slider, the door lock slider is provided with a door hook hole matching the door hook, and the control device controls the opening or closing of the door within an opening range by controlling the door lock slider to be extended by a distance or retracted, and thus achieving automatic opening of the door to a heat dissipation position or automatic closing of the door from the heat dissipation position.

Specifically, if the door needs to be opened by a gap, for example, the door needs to be in the heat dissipation position, the door lock slider can remain in an extended position by means of the cooperative arrangement of a biasing device and the door lock slider in the door lock device. When the door gap is to be closed, a motor in the driving device is driven to overcome a biasing force of the biasing device and drive the door lock slider to move from the extended position to a retracted position, and in this case, biasing potential energy is stored in the biasing device; when the door gap needs to be opened again, the motor rotates reversely to gradually release a pull force on the biasing device, such that the biasing device can cause the door lock slider to move from the retracted position to the extended position under the action of the stored biasing potential energy, thus pushing the door to be opened by a distance.

In the process of completing heat dissipation and closing the door of the dishwasher, the control device activates an automatic door closing program, and the driving motor pulls back the door lock slider from the extended position to the retracted position. If there is a foreign object or an obstacle in the door gap at this moment, for example, a user accidentally reaches his/her hand into the door gap, the obstacle may be clamped during the door closing process and thus the door cannot be closed normally.

In addition, in the process of the dishwasher executing a heat dissipation program, if the user manually intervene to pull the door open, the door lock slider is disengaged from the door hook of the door, and thus the door lock slider extends out to be separately exposed to the outside of the dishwasher; and if the user manually intervenes to push the door to a closed position, although the door lock slider moves to the retracted position under the action of a push force on the door, since the door lock slider is connected to the driving component by means of a flexible rope, the rope blocks the push force on the door lock slider from the driving component, the motor and a driving rack of the driving component remain in a position corresponding to the extended position of the door lock slider without reset, and thus a subsequent automatic door opening operation is affected.

Therefore, there is a need for a door lock device of a dishwasher and a control method therefor, in order to, regardless of the position of the door of the dishwasher, stop door closing or move the door in an opening direction as long as an obstacle is detected in a door closing process. Further, there is a need for a door lock device of a dishwasher and a control method therefor, such that in the process of executing a heat dissipation program of the dishwasher, even if a user manually intervenes a door opening or closing operation, there is a set of control programs for responding to the manual intervention from the user, which does not affect normal operations of the (heat dissipation) program of the dishwasher, and the door lock slider is not separately exposed to the outside of the dishwasher, or a driving motor resets a driving rack to not affect a next automatic door opening operation.

Therefore, according to a first aspect of the present disclosure, a control method is provided for controlling a motor of a door lock device, the motor being configured to drive a door lock slider to move, and the door lock slider being configured to actuate a door of an electrical apparatus, wherein the control method includes: step S01, controlling the motor to rotate in a first direction of rotation to allow the door lock slider to be retracted so as to move the door toward a closed position if the door is in a non-closed position; step S02, determining whether there is an obstacle in a gap with which the door is opened in the process of the door moving toward the closed position; controlling the motor to rotate in a second direction of rotation opposite the first direction of rotation for a first predetermined period of time if there is an obstacle in the gap, and controlling the motor to rotate in the first direction of rotation after the first predetermined period of time ends; and repeating the aforementioned operations in step S02 until the obstacle is removed from the gap; and step S03, moving the door to the closed position.

According to the first aspect of the present disclosure, in step S01, if there is a manual intervention, the following steps are performed: step S01-1, controlling the motor to rotate in the first direction of rotation to allow the door lock slider to be retracted if the manual intervention is manual door opening and the door lock slider is disengaged from the door; performing a manual door closing operation after the door is kept in an open position for a period of time, and proceeding to step S03 after the manual door closing operation is completed; or step S01-2, controlling the motor to rotate in the first direction of rotation if the manual intervention is manual door closing, and proceeding to step S03 after the manual door closing operation is completed.

According to the first aspect of the present disclosure, in step S02, whether there is an obstacle in the gap is determined by means of measuring a current change of the motor.

According to the first aspect of the present disclosure, in step S02, whether there is an obstacle in the gap is determined by means of measuring a change of an infrared signal, a photoelectric signal or a capacitive signal in the gap.

According to the first aspect of the present disclosure, prior to step S01, the control method further has the following steps: step S011, closing the door, and performing a dish washing operation with the door in the closed position, and in this case, the door lock slider being in a retracted position and connected to the door; and step S012, controlling the motor to rotate in the second direction of rotation to allow the door lock slider to be extended out, so as to move the door toward a predetermined position; and step S013, opening the door with the gap and keeping the door for a second predetermined period of time in a state of being opened with the gap when the door is in the predetermined position, the door lock slider being in an extended position and keeping in connection with the door; and after the second predetermined period of time ends, proceeding to step S01.

According to the first aspect of the present disclosure, the electrical apparatus performs a heat dissipation operation within the second predetermined period of time.

According to the first aspect of the present disclosure, in step S02, the motor is controlled to continue to rotate in the first direction of rotation and it proceeds to step S03 if there is no obstacle in the gap or if the obstacle is removed from the gap.

According to the first aspect of the present disclosure, in step S012, if there is a manual intervention, the following steps are performed: step S012-1, controlling the motor to rotate in the first direction of rotation to allow the door lock slider to be retracted if the manual intervention is manual door opening and the door lock slider is disconnected from the door; and performing a manual door closing operation after the door is kept in an open position for a period of time, and proceeding to step S03 after the manual door closing operation is completed; or step S012-2, controlling the motor to rotate in the first direction of rotation if the manual intervention is manual door closing, and proceeding to step S03 after the manual door closing operation is completed.

According to a second aspect of the present disclosure, a door lock device is provided, the door lock device including a motor, a door lock slider, an obstacle detection component, and a control device, the control device being configured to control the rotation of the motor, the motor being configured to drive the door lock slider to move, and the door lock slider being configured to actuate a door of an electrical apparatus, wherein the door lock device is configured to open or close the door by means of the control method according to the first aspect of the disclosure.

According to a third aspect of the present disclosure, a door lock device is provided for opening and closing a door of an electrical apparatus, wherein the door lock device includes: a door lock assembly, a driving assembly, an obstacle detection component, and a control device. The door lock assembly is configured to actuate the door, the door lock assembly including a door lock slider having an extended position and a retracted position. The driving assembly is connected with the door lock slider for allowing the door lock slider to reciprocate between the extended position and the retracted position. The obstacle detection component is configured to detect whether there is an obstacle in a gap with which the door is opened. The control device is configured to control the driving assembly based on a detection result from the obstacle detection component. The control device is configured to control the driving assembly to allow the door lock slider to move to the extended position so as to allow the door to move in a direction opposite a closed position when the door lock slider drives the door to move to the closed position and the obstacle detection component detects that there is an obstacle in the gap with which the door is opened.

According to the third aspect of the present disclosure, the door lock device further includes: a driving motor configured to drive the driving assembly, wherein the control device is configured to control a rotation direction of the driving motor so as to control a movement of the driving assembly.

According to the third aspect of the present disclosure, the obstacle detection component is a current detection component for detecting a current flowing through the driving motor.

According to the third aspect of the present disclosure, the obstacle detection component is a photosensitive detection component, an infrared detection component or a capacitive detection component for detecting whether there is an obstacle in the gap with which the door is opened.

According to the third aspect of the present disclosure, the door lock assembly further includes a positioning switch and a door switch. The control device is configured to control a rotation of the driving motor based on states of the positioning switch and the door switch. The positioning switch is switched off when the door lock slider is in the retracted position, and the positioning switch is switched on when the door lock slider is not in the retracted position, and the door switch is switched off when a door hook of the door is engaged with the door lock slider, and the door switch is switched on when the door hook of the door is disengaged from the door lock slider.

According to the third aspect of the present disclosure, the door has an open position, the closed position and one or more intermediate positions between the open position and the closed position. When the door is in the closed position, the door lock slider is in the retracted position, the positioning switch is switched off, and the door switch is switched off. When the door is in the one or more intermediate positions, the door lock slider is in the extended position, the positioning switch is switched on, and the door switch is switched off. When the door is in the open position, the door lock slider is in the retracted position, the positioning switch is switched off, and the door switch is switched on.

According to the third aspect of the present disclosure, the driving assembly includes: a driving gear and a driving rack, the driving gear being configured to be rotatable in a first direction of rotation or a second direction of rotation, the driving rack being engaged with the driving gear, the driving gear being configured to drive the driving rack to reciprocate in a first linear direction or a second linear direction, and the driving rack being connected to the door lock slider, so as to further cause the door lock slider to move.

According to the third aspect of the present disclosure, the control device is configured to control the direction of rotation of the driving gear. The driving rack drives the door lock slider to move in the first linear direction such that the door lock slider is in the retracted position when the control device controls the driving gear to rotate in the first direction of rotation. The control device controls the driving gear to rotate in the second direction of rotation such that the door lock slider is capable of moving to the extended position in the second linear direction when the obstacle detection component detects that there is an obstacle in the gap with which the door is opened.

According to the third aspect of the present disclosure, the door lock assembly further includes: a biasing device configured such that the door lock slider causes the biasing device to store a biasing force when the door lock slider moves in the first linear direction, and the biasing force stored in the biasing device is capable of driving the door lock slider to move from the retracted position to the extended position in the second linear direction when the driving gear rotates in the second direction of rotation.

According to the third aspect of the present disclosure, when the door is controlled to move from the closed position to the one or more intermediate positions, the control device controls the driving gear to rotate in the second direction of rotation such that the door lock slider moves from the retracted position to the extended position; when the door is controlled to move from the one or more intermediate positions to the closed position, the control device controls the driving gear to rotate in the first direction of rotation such that the door lock slider moves from the extended position to the retracted position; when the door is manually moved from the closed position to the open position, the control device does not control the driving gear to rotate, and the door lock slider remains in the retracted position; and when the door is manually moved from the one or more intermediate positions to the open position, the control device controls the driving gear to rotate in the first direction of rotation such that the door lock slider moves from the extended position to the retracted position.

According to the third aspect of the present disclosure, the door lock device further includes a flexible component, the door lock slider being connected to the driving assembly by means of the flexible component. When the driving gear rotates in the first direction of rotation, the driving rack pulls the door lock slider to move in the first linear direction by pulling the flexible component, so as to move the door lock slider to the retracted position. When the door lock slider is in the extended position and the door lock slider is pushed toward the retracted position, the flexible component can isolate a push force generated by the movement of the door lock slider, such that the driving assembly is not affected by the push force.

According to a fourth aspect of the present disclosure, an electrical apparatus is provided, the electrical apparatus having a door, wherein the electrical apparatus is configured to open or close the door by means of a control method according to the first aspect of the disclosure.

According to a fifth aspect of the present disclosure, an electrical apparatus is provided, the electrical apparatus having a door lock device according to the second and third aspects of the disclosure and a door.

Some of the additional aspects and advantages of the present disclosure will be set forth in the following description, and some will be apparent from the following description, or be learned by practice of the present disclosure.

### BRIEF DESCRIPTION OF SEVERAL VIEWS OF THE DRAWINGS

FIG. 1A is a schematic diagram of a dishwasher having a door lock device of the present disclosure, with a door of the dishwasher being in an open position;

FIG. 1B is a schematic diagram of the dishwasher shown in FIG. 1A, with the door of the dishwasher being in a closed position;

FIG. 1C is a schematic diagram of the dishwasher shown in FIG. 1A, with the door of the dishwasher being in a heat dissipation position;

FIG. 2A is a perspective view of the door lock device of the present disclosure;

FIG. 2B is an exploded mounting view of the door lock device shown in FIG. 2A;

FIG. 2C is a perspective view of another embodiment of the door lock device of the present disclosure;

FIG. 2D is a top view of a door lock slider in a retracted position, with a door lock box upper cover hidden to show more components inside a door lock box;

FIG. 2E is a top view of the door lock slider in an extended position, with the door lock box upper cover hidden to show more components inside the door lock box;

FIG. 3A is a perspective view of the door lock box, with the door lock box upper cover of the door lock box hidden to show more components inside the door lock box;

FIG. 3B is a partial enlarged perspective view of the door lock slider shown in FIG. 3A;

FIG. 3C is an exploded mounting view of the door lock box shown in FIG. 3A;

FIG. 4A is a perspective view of a driving assembly, with a driving device upper cover of the driving assembly hidden to show more components inside the driving assembly;

FIG. 4B is an exploded mounting view of the driving assembly shown in FIG. 4A;

FIG. 4C is a block diagram of connection and control of a driving motor;

FIG. 5A is a schematic diagram of the door lock slider in the extended position;

FIG. 5B is a schematic diagram of the door lock slider in the retracted position;

FIG. 5C is a schematic diagram of the door lock slider that is forced back from the extended position to the retracted position;

FIG. 6A is a control logic diagram of closing the door of the dishwasher;

FIG. 6B is a flow chart of a resetting process of the door of the dishwasher;

FIG. 6C is a flow chart of activating a dish washing program and a heat dissipation program after resetting of the door of the dishwasher is completed;

FIG. 7A is a block diagram of a control device, in which an obstacle detection component is a current detection component;

FIG. 7B is a circuit diagram of a motor control part of the control device shown in FIG. 7A;

FIG. 7C is a circuit diagram of a switching signal and door opening operation signal control part of the control device shown in FIG. 7A; and

FIG. 7D is a block diagram of a control device, in which the obstacle detection component is an obstacle sensor.

### DESCRIPTION OF PREFERRED EMBODIMENTS

Various specific embodiments of the present disclosure will be described below with reference to the accompanying drawings which form part of the present disclosure, but the embodiments do not limit the present disclosure. It should be understood that although the terms indicating orientations, such as “upper”, “lower”, “left”, “right”, “front”, “rear”, are used in the present disclosure to describe orientations of various illustrative structural parts and elements in the present disclosure, these terms used herein are merely for ease of description and are determined based on the illustrative orientation shown in the accompanying drawings. Since the embodiments disclosed in the present disclosure can be arranged in different orientations, these terms indicating directions are merely illustrative and should not be considered as limitations.

The terms “first”, “second”, “third”, etc. used in the present disclosure are merely used to distinguish different objects, instead of indicating that there is any particular sequential relationship between these objects. The term “comprise/include” and derivatives thereof mean inclusion without limitation. Unless otherwise specified and limited, the terms “mounting”, “connecting” and “connection” should be understood broadly. For example, they may be a mechanical or electrical connection, internal communication between two elements, or a direct connection or indirect connection via an intermediate medium. For those of ordinary skills in the art, the specific meanings of the above terms can be understood according to specific cases. If possible, the same or similar reference numerals used in the present disclosure refer to the same elements.

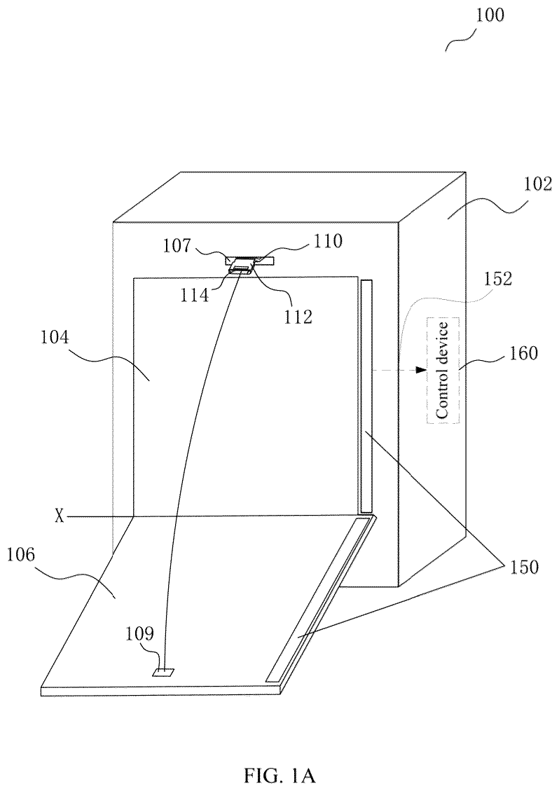

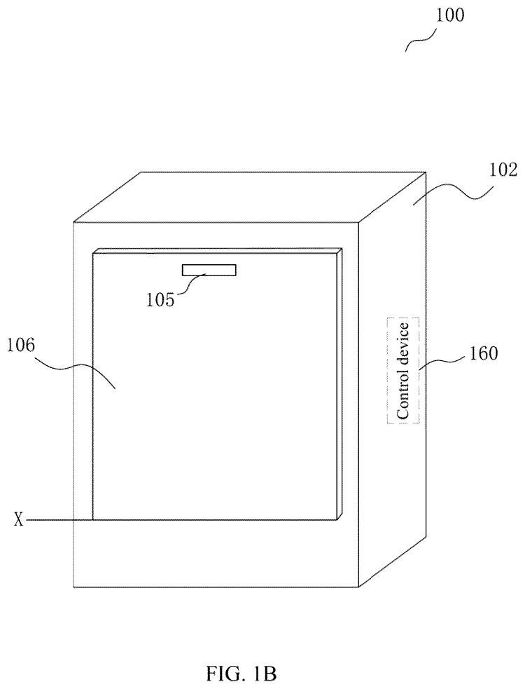

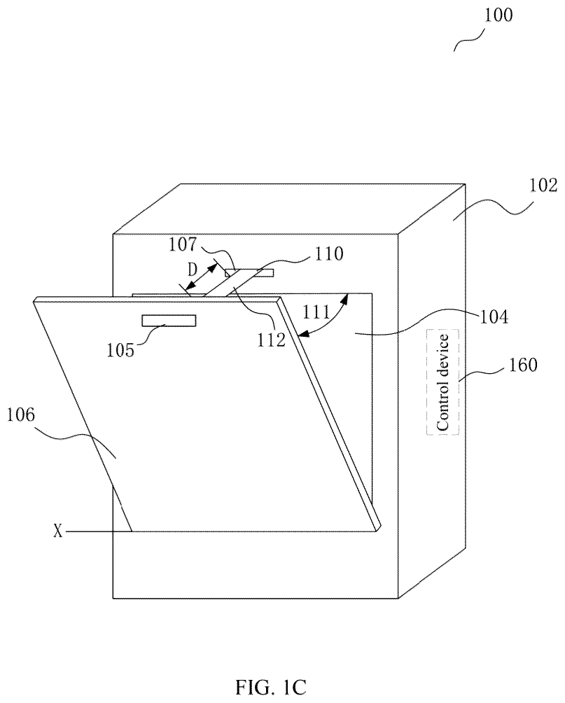

FIGS. 1A-1C are schematic diagrams of a dishwasher 100 having a door lock device 110 of the present disclosure, with a door of the dishwasher being in an open position, a closed position or one or more intermediate positions, such as a heat dissipation position.

As shown in FIGS. 1A-1C, the dishwasher 100 has a dishwasher body 102, a cavity 104 for accommodating dishes, and a dishwasher door 106 for closing the cavity 104. The dishwasher door 106 can pivot about a pivot axis X to open or close the dishwasher door 106. Therefore, the dishwasher door 106 has three critical positions during a movement process: an open position, a closed position and a heat dissipation position, which correspond to the three positions shown in FIGS. 1A-1C, respectively, where the heat dissipation position is located between the open position and the closed position. For those of ordinary skill in the art, the dishwasher door 106 may further have any position between any two of the above-mentioned three positions during the movement process, for example, any position between the heat dissipation position and the closed position, or any position between the heat dissipation position and the open position.

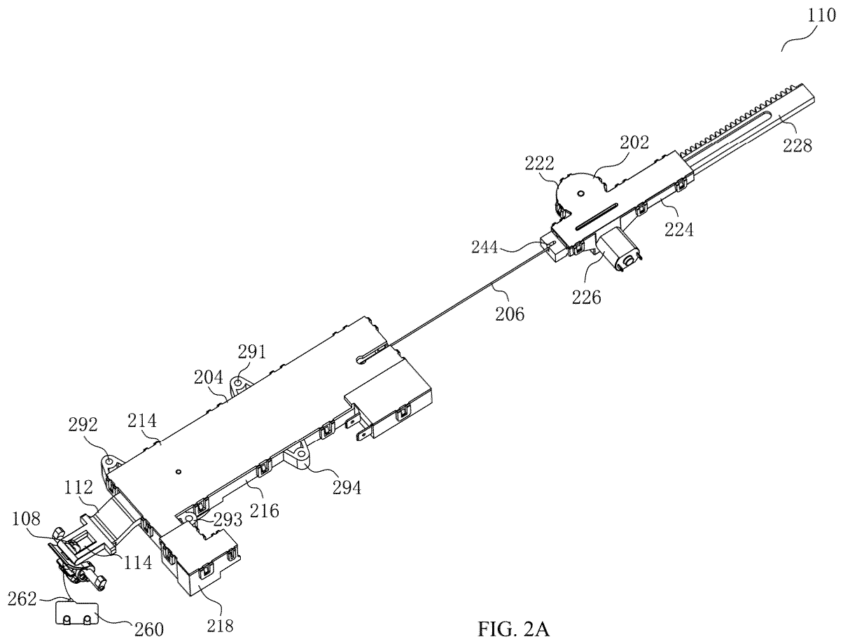

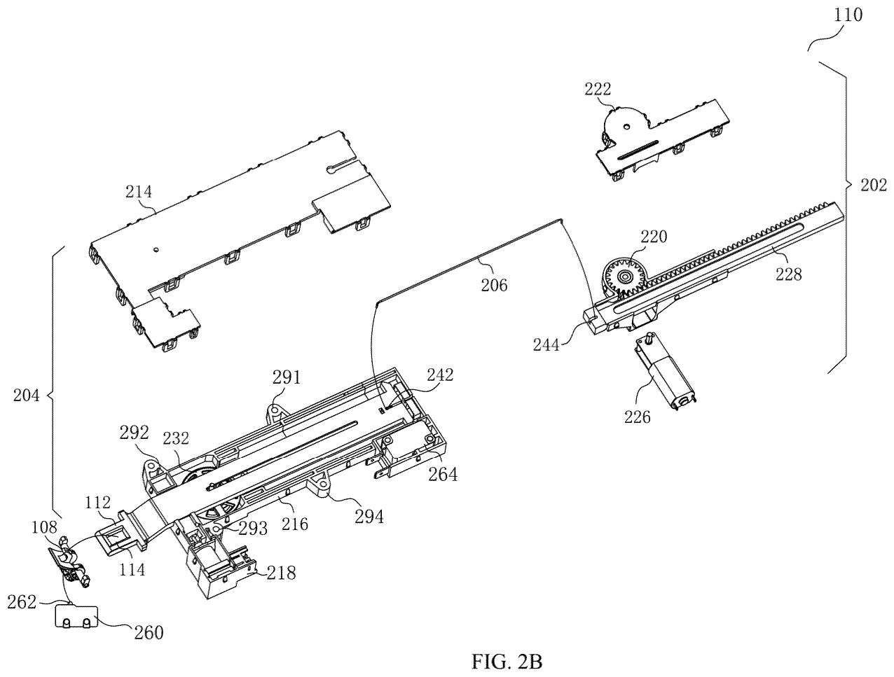

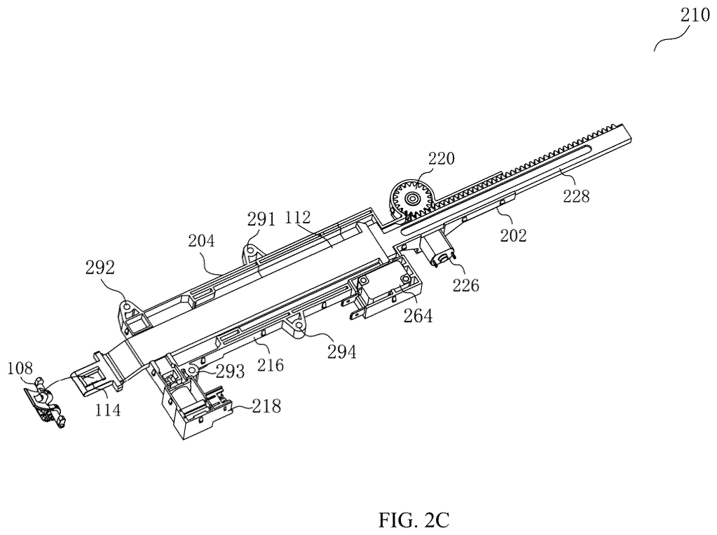

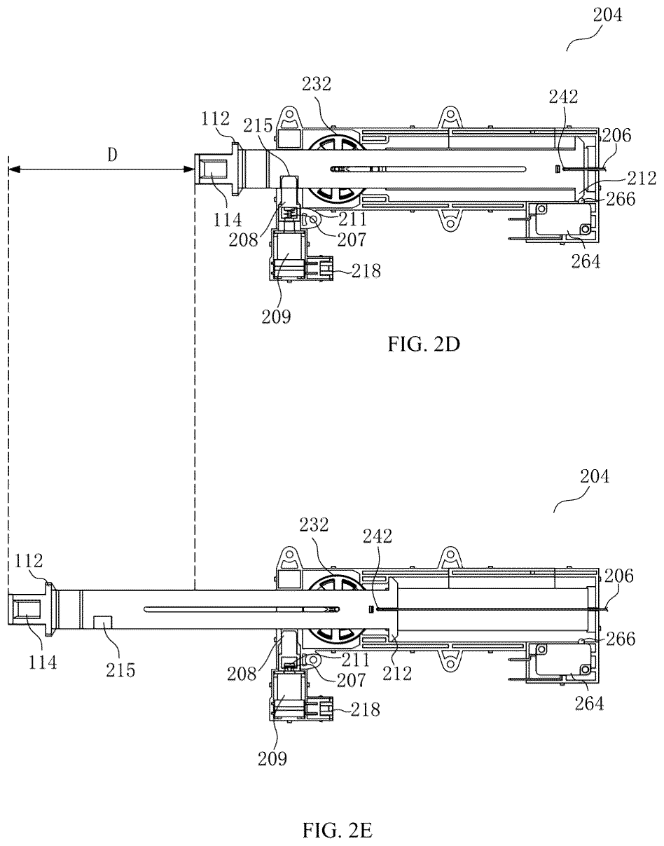

Still referring to FIGS. 1A-1C, the door lock device 110 is mounted inside the dishwasher body 102, the door lock device 110 has a door lock slider 112, and a door hook hole 114 is formed in an end of the door lock slider 112. The door lock slider 112 can be extended from a door lock device extension hole 107 formed in the dishwasher body 102, and engaged with the door hook 108 (see FIG. 2A) by means of the door hook hole 114. Therefore, the door lock slider 112 has two critical positions of movement, that is, an extended position and a retracted position.

A door latch is provided inside the dishwasher door 106 and includes the above-mentioned door hook 108, and a door latch handle 105 for pulling the door latch is provided on an outer side of the dishwasher door 106 and configured to disengage the door hook 108 of the door latch from the door hook hole 114, such that the dishwasher door 106 can be pulled open. A door latch hole 109 is formed in an inner side of the dishwasher door 106 at a position corresponding to the door latch, such that the door lock slider 112 can pass through the door latch hole 109 to be inserted into the door latch and thus be engaged with the door hook 108 inside the dishwasher door 106. In a state that the door lock slider 112 is disengaged from the door hook 108, once the dishwasher door 106 or the door hook 108 bumps against the door lock slider 112, the door hook 108 may be re-engaged with the door hook hole 114 of the door lock slider 112 to allow the dishwasher door 106 to be closed or to allow the dishwasher door 106 to move under the drive of the door lock slider 112.

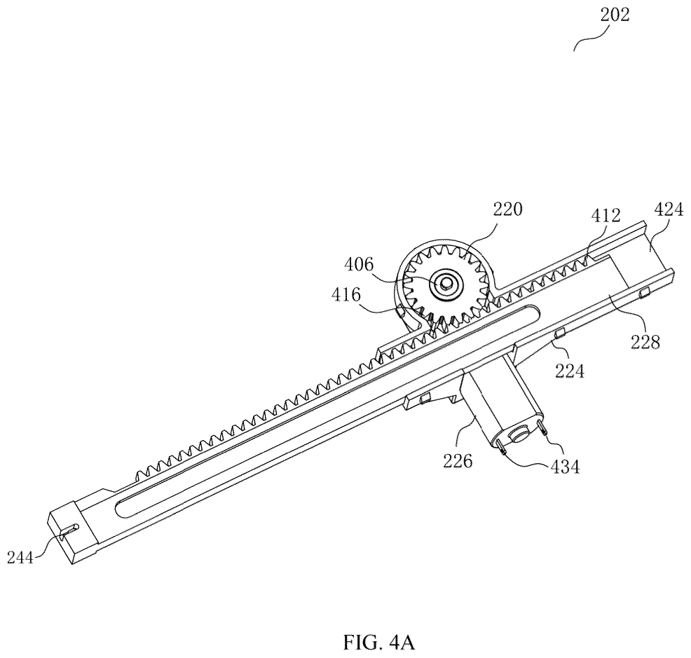

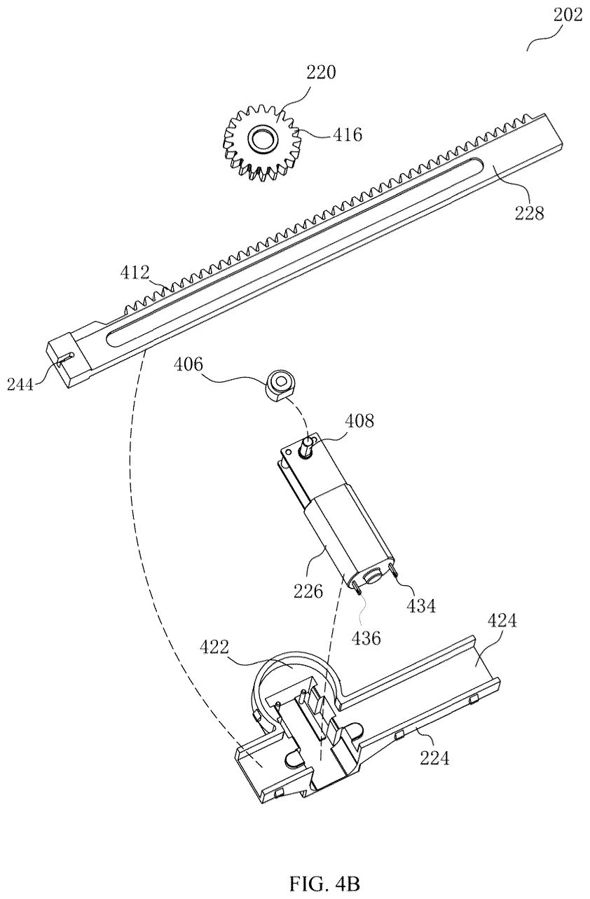

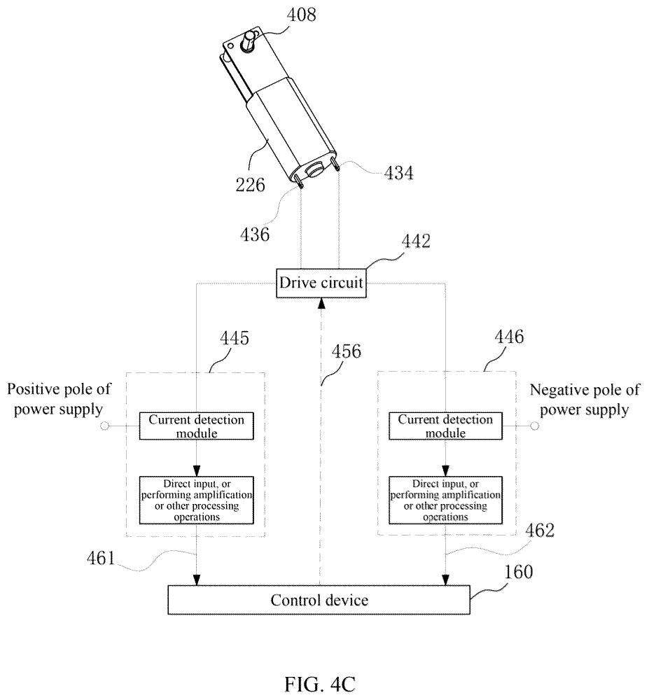

The dishwasher 100 is further provided with a control device 160 and an obstacle detection component. The control device 160 is configured to control and actuate the movement of the door lock slider 112 and to receive an obstacle signal, and the obstacle detection component is configured to detect whether there is an obstacle in a door gap 111 (see FIG. 1C) (e.g., a user accidentally reaching his/her hand into the gap) during the closing process of the dishwasher door 106. The obstacle detection component may be a current detection component 445/446 (see FIG. 4C), that is, the current detection component 445/446 detects a current change of a driving motor 226 (see FIGS. 2A-2C and FIGS. 4A-4C) to determine whether there is an obstacle in the door gap 111. The obstacle detection component may also be an obstacle sensor 150, such as a photoelectric (photosensitive) sensor, an infrared sensor or a capacitive sensor (see FIG. 1A), which is disposed between the dishwasher door 106 and the dishwasher body 102. It is determined whether there is an obstacle in the door gap 111 based on the obstacle signal detected by the obstacle sensor 150, and a signal indicating whether there is an obstacle is transmitted to the control device 160 by means of a connecting line 152.

If it is detected that there is an obstacle in the door gap 111 during the movement of the dishwasher door 106 from the heat dissipation position to the closed position under the control of the control device 160, the control device 160 controls the dishwasher door 106 to stop closing or move reversely, so as to avoid further clamping of the obstacle.

FIG. 1A is a schematic diagram of the dishwasher door 106 of the present disclosure in the open position.

As shown in FIG. 1A, when the dishwasher door 106 is in the open position, the door lock slider 112 is disengaged from the door hook 108. Normally, when the dishwasher door 106 is in the open position, the door lock slider 112 does not extend from the door lock device extension hole 107. Even if the door lock slider 112 is in the extended position, the control device 160 of the dishwasher 100 can also control the door lock slider to be retracted into the door lock device extension hole 107 (a specific control flow will be described in detail later).

FIG. 1B is a schematic diagram of the dishwasher door 106 of the present disclosure in the closed position.

As shown in FIG. 1B, when the dishwasher door 106 is in the closed position, the door lock slider 112 is engaged with the door hook 108, and the door lock slider 112 is in the retracted position. In this case, the control device 160 of the dishwasher 100 can control a distance by which the door lock slider 112 extends out, so as to open the dishwasher door 106 and adjust the size of the gap with which the dishwasher door 106 is opened.

FIG. 1C is a schematic diagram of the dishwasher door 106 of the present disclosure in the heat dissipation position.

As shown in FIG. 1C, when the dishwasher door 106 is in the heat dissipation position, the door lock slider 112 is engaged with the door hook 108, and the door lock slider 112 is in the extended position. For example, the door lock slider 112 shown in FIG. 1C extends out by a distance D (see FIGS. 2D and 2E) relative to the retracted position thereof. In this case, the dishwasher door 106 is opened with a maximum gap while the dishwasher door remains engaged with the door lock slider 112, that is, it can be approximately regarded as that the door gap 111 of the dishwasher in FIG. 1C has a width D. The door gap 111 is used for subsequent drying and heat dissipation operation of the dishwasher 100 after a cleaning operation is completed. When the dishwasher door 106 is in the heat dissipation position, if it is required to open the dishwasher door 106 further, the user needs to pull the door latch handle 105 by means of manual intervention to disengage the door lock slider 112 from the door hook 108, so as to pull the dishwasher door 106 open.

The dishwasher 100 shown in FIGS. 1A-1C is merely exemplary, and the door lock device 110 of the present disclosure can also be mounted on various types of electrical apparatuses having a cavity and a door for closing the cavity, such as a washing machine, a laundry dryer, a microwave oven, and can also be mounted on other non-electrical apparatuses.

FIGS. 2A-2C are perspective views of two embodiments of the door lock device of the present disclosure.

FIG. 2A is a perspective view of the door lock device 110 of the present disclosure, which shows main components of the door lock device 110.

As shown in FIGS. 2A, the door lock device 110 includes a door lock assembly (e.g., a door lock box 204), a driving assembly 202 and a flexible component (e.g., a rope 206). The door lock box 204 includes a door lock box upper cover 214 and a door lock box housing 216, an elongated door lock slider 112 is disposed inside the door lock box, and the door lock slider 112 can reciprocate linearly relative to the door lock box 204 in a length direction of the door lock slider. A door hook hole 114 is formed in one end (e.g., the left end shown in the figure) of the door lock slider 112 and configured to receive the door hook 108 mounted in the door latch and can be engaged with the door hook 108, and a slider rope receiving hole 242 (see FIG. 2B) is formed in the other end (e.g., the right end shown in the figure) of the door lock slider 112 and configured to connect the rope 206. Four door lock box fixing members 291, 292, 293, 294 are provided on the door lock box housing 216 of the door lock box 204 and configured to fixedly mount the door lock box 204 inside the dishwasher body 102.

Still referring to FIGS. 2A, a door switch 260 is disposed at an inner side of the dishwasher door 106, and the door switch 260 has a door switch contact 262. In an embodiment of the present disclosure, when the door hook hole 114 in the door lock slider 112 is engaged with the door hook 108, a rotating cam (not shown) of the door hook 108 is in a position where the rotating cam is in contact with the door switch contact 262, so as to switch off the door switch 260; and when the door hook hole 114 in the door lock slider 112 is disengaged from the door hook 108, the rotating cam of the door hook 108 swings to a position where the rotating cam is not in contact with the door switch contact 262, so as to switch on the door switch 260. As known to those skilled in the art, in other embodiments, ON and OFF of the door switch 260 may also be set to be contrary to those in the above embodiment, as long as it can be ensured that the ON and OFF of the door switch 260 can distinguish and indicate the engagement or disengagement between the door hook hole 114 and the door hook 108.

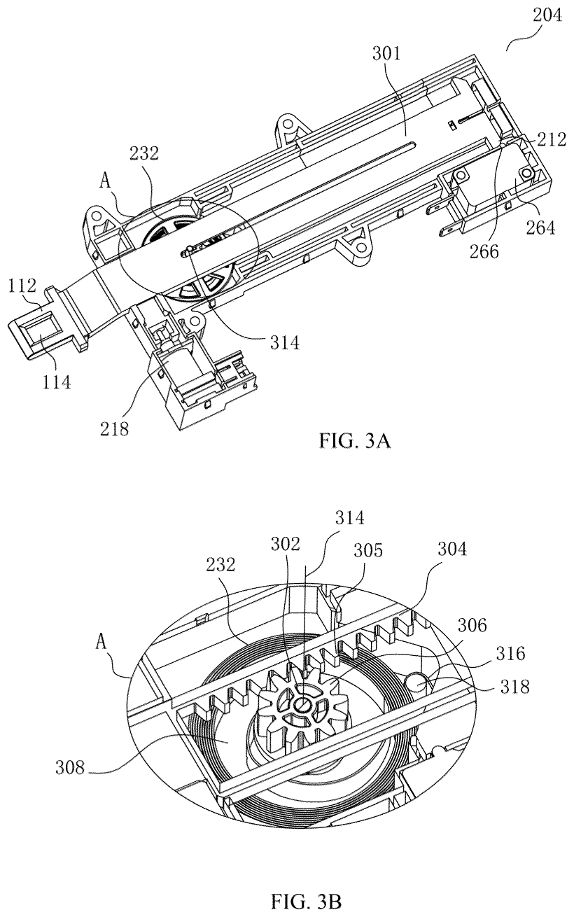

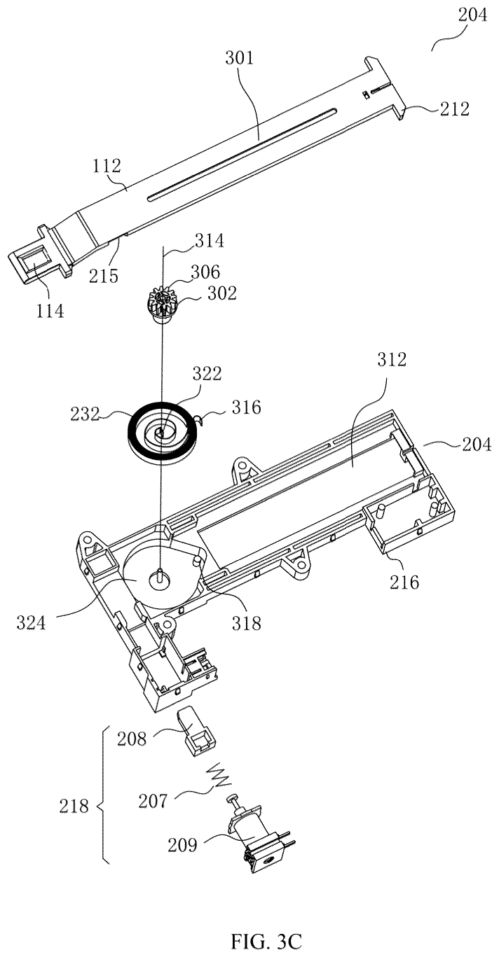

Still referring to FIGS. 2A, the driving assembly 202 includes a driving device upper cover 222 and a driving device housing 224, a driving rack 228 is disposed inside the driving assembly, and the driving rack 228 can reciprocate linearly relative to the driving assembly 202. A rack pulling rope receiving hole 244 is formed in an end (e.g., the left end shown in the figure) of the driving rack 228 and configured to connect the rope 206. The driving assembly 202 further includes a driving motor 226, which is preferably a servo motor, configured to drive the driving rack 228 to reciprocate. Thus, it can be seen that the door lock slider 112 and the driving rack 228 can be connected together by means of the rope 206, and a rightward movement of the driving rack 228 relative to the driving assembly 202 can cause a rightward movement of the door lock slider 112 relative to the door lock box 204; and a pull force on the door lock slider 112 can be released by means of a leftward movement of the driving rack 228 relative to the driving assembly 202, so as to allow the door lock slider 112 to move leftward, and the leftward movement of the door lock slider 112 is caused by an elastic potential energy stored in a biasing device (e.g., a coil spring) 232 (see FIGS. 3A-3C).

FIG. 2B is an exploded mounting view of the door lock device 110 shown in FIG. 2A. In FIG. 2B, the door lock box upper cover 214 of the door lock box 204 and the driving device upper cover 222 of the driving assembly 202 in FIG. 2A are removed to show more components inside the door lock box 204 and the driving assembly 202.

As shown in FIG. 2B, the door lock slider 112 is disposed inside the door lock box 204. As viewed from the top, the door lock slider 112 is disposed at an upper portion of the door lock box 216, and the biasing device, preferably the coil spring 232, which is cooperatively connected to the door lock slider 112, is disposed below the door lock slider 112. The coil spring 232 can generate a leftward biasing force on the door lock slider 112 by means of its own torsion, to allow the door lock slider 112 to have a tendency to move from a retracted position to an extended position. A locking pin assembly 218 arranged perpendicular to the door lock slider 112 is disposed below the left side of the door lock box 204 and configured to lock the door lock slider 112 in the retracted position shown in FIG. 2A. A positioning switch 264 for detecting a position of the door lock slider 112 is disposed inside the door lock box 204 and configured to indicate whether the door lock slider 112 is in the retracted position.

A driving gear 220 is disposed inside the driving assembly 202 and can maintain in tooth engagement with the driving rack 228. The driving motor 226 can actuate the driving gear 220 to rotate and cause the driving rack 228 to reciprocate linearly by means of the engagement transmission between the driving gear 220 and the driving rack 228.

For those of ordinary skill in the art, in some other embodiments, for example, if there is an enough space inside an electrical apparatus to arrange the door lock device 110, without providing the rope 206, the door lock slider 112 and the driving rack 228 can be rigidly connected and arranged to move in the same movement direction, for which reference may be made to the description of FIG. 2C below.

FIG. 2C is a perspective view of another embodiment of the door lock device of the present disclosure, and the door lock box upper cover 214 of the door lock box 204 is hidden in FIG. 2C, so that a connecting relationship between the door lock slider 112 and the driving rack 228 can be more clearly seen.

As shown in FIG. 2C, the differences between the door lock device 210 and the door lock device 110 shown in FIGS. 2A and 2B are that the door lock slider 112 and the driving rack 228 of the door lock device 210 are directly rigidly connected together instead of by means of flexible connection by the rope 206, and the biasing device 232 of the door lock device 110 in FIGS. 2A and 2B is not provided in the door lock device 210. Other identical parts will not be repeated. Since the door lock slider 112 and the driving rack 228 of the door lock device 210 are rigidly connected, the driving rack 228 can be actuated to reciprocate by the driving motor 226, so as to cause the door lock slider 112 to reciprocate between the extended position and the retracted position.

FIGS. 2D and 2E are top views showing the door lock slider 112 in the door lock box 204 in the retracted position and the extended position, respectively. In FIGS. 2D and 2E, the door lock box upper cover 214 of the door lock box 204 is hidden to show a cooperation relationship of various components inside the door lock box 204 and to show a movement distance of the door lock slider 112 between the retracted position and the extended position, so as to reflect a gap distance by which the dishwasher door 106 can be opened.

As shown in FIGS. 2D and 2E, the positioning switch 264 has a positioning switch contact 266, a downward protruding switch actuating portion 212 is disposed at a right end of the door lock slider 112 at a position corresponding to the positioning switch 264. The door lock slider 112 can linearly reciprocate in the door lock box 204. Therefore, the switch actuating portion 212 of the door lock slider 112 also reciprocate with the movement of the door lock slider 112.

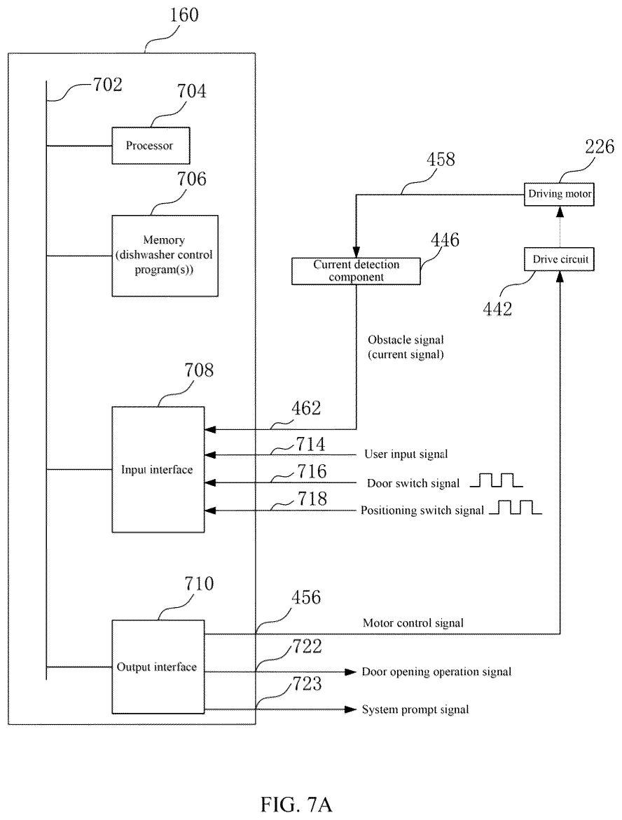

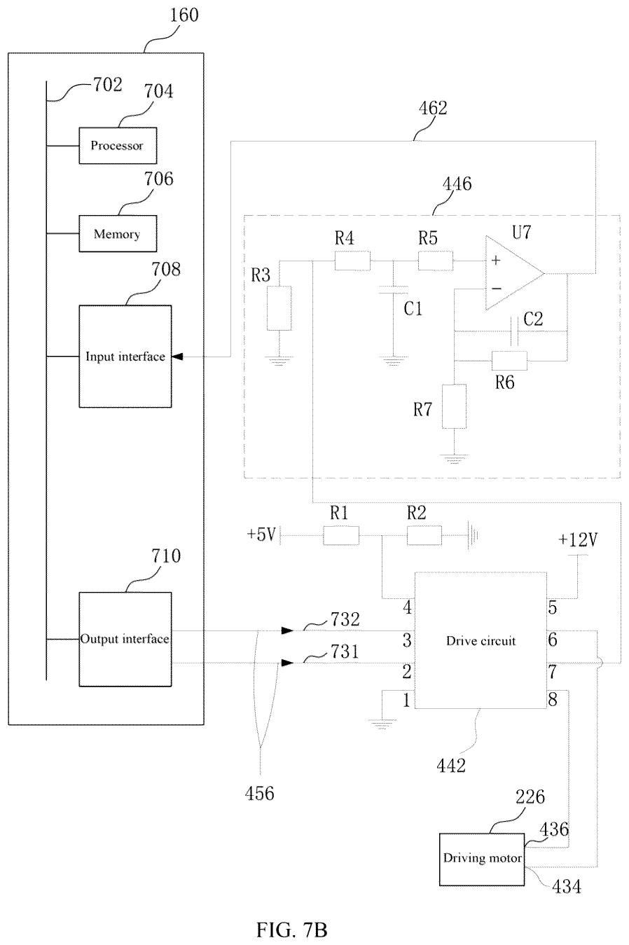

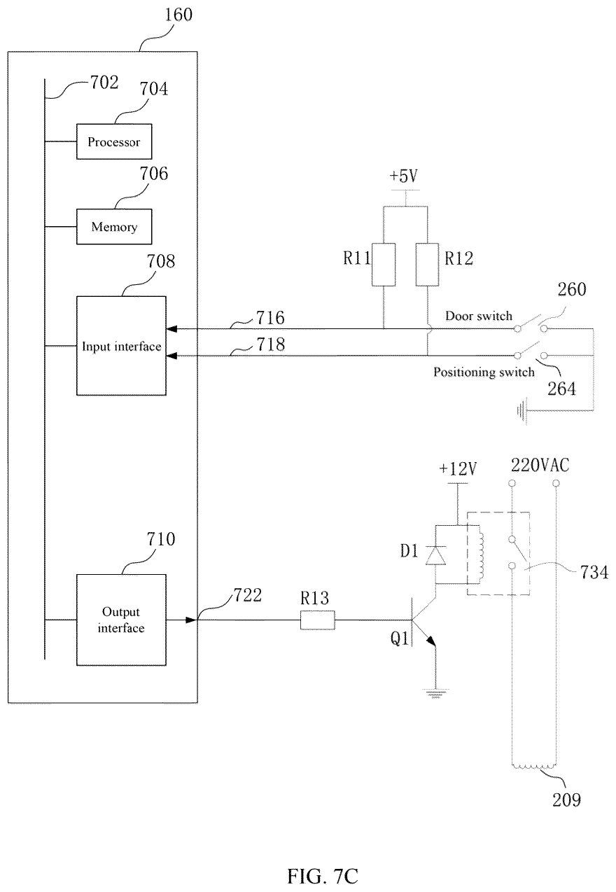

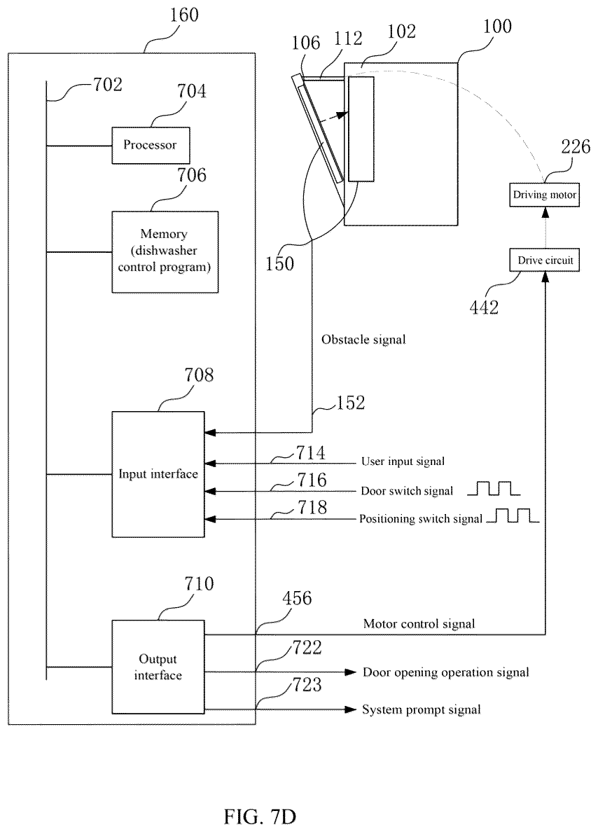

Specifically, as shown in FIG. 2D, when the door lock slider 112 moves to the retracted position, the switch actuating portion 212 of the door lock slider 112 is in contact with the positioning switch contact 266 of the positioning switch 264 to switch off the positioning switch 264. In this case, the positioning switch 264 can send a signal indicative of the door lock slider 112 being in the retracted position to the control device 160 (see FIGS. 7A-7D) of the electrical apparatus, so as to execute a control program for a next operation. Similarly, as shown in FIG. 2E, when the door lock slider 112 moves away from the retracted position, for example, moves to the extended position, the switch actuating portion 212 of the door lock slider 112 is out of contact with the positioning switch contact 266 of the positioning switch 264 to switch on the positioning switch 264, and in this case, the positioning switch 264 can send a signal indicative of the door lock slider 112 moving away from the retracted position to the control device 160 of the electrical apparatus, so as to execute the control program for a next operation. For those of ordinary skill in the art, the positioning switch 264 may not be provided in the door lock box 204. For example, the movement of the door lock slider 112 may be limited by providing a corresponding mechanical limiting structure in the door lock box 204, and the movement distance of the door lock slider 112 may be controlled or the position of the door lock slider 112 may be detected by controlling a rotational speed and a rotational duration of the servo motor.

Still referring to FIGS. 2D and 2E, when the door lock slider 112 moves from the retracted position to the extended position, the door lock slider 112 moves leftward by the distance D. Without manually pulling the dishwasher door 106, the door hook 108 remains engaged with the door hook hole 114 of the door lock slider 112 during the movement of the door lock slider 112 from the retracted position to the extended position, the dishwasher door 106 correspondingly moves about the pivot axis X from the closed position to the heat dissipation position, the door is opened by the distance D, that is, the opening of the door gap 111 is D (see FIG. 1C).

Still referring to FIGS. 2D and 2E, the locking pin assembly 218 inside the door lock box 204 includes a locking pin 208, a locking pin spring 207 and a linear motor which is preferably a locking pin coil 209. The locking pin coil 209 has a movable actuating rod 211 for actuating the movement of the pin 208. The locking pin spring 207 is disposed between the locking pin 208 and the actuating rod 211 of the locking pin coil 209 and can provide an elastic force (a resetting force) for moving the locking pin 208 away from the locking pin coil 209. The locking pin coil 209 can receive a pulse signal from the control device 160 (see FIGS. 7A-7D) to provide an electromagnetic force for moving the locking pin 208 close to the locking pin coil 209, and the electromagnetic force can overcome a maximum elastic force generated by the locking pin spring 207. At the retracted position of the door lock slider 112, a locking pin slot 215 is formed in a lower portion of the door lock slider 112 at a position corresponding to the locking pin 208, and is configured to receive the inserted locking pin 208. Specifically, as shown in FIG. 2D, in the retracted position of the door lock slider 112, if no pulse signal is provided, the locking pin 208 is automatically inserted (sprung) into the locking pin slot 215 in the lower portion of the door lock slider 112 under the action of the locking pin spring 207 to lock the door lock slider 112. When the locking pin coil 209 receives the pulse signal, the electromagnetic force can be generated to overcome the elastic force of the locking pin spring 207, so as to pull back the locking pin 208 to a non-locked position as shown in FIG. 2E. When the door lock slider 112 moves to a position other than the retracted position, since the locking pin 208 cannot be aligned with the locking pin slot 215, the locking pin 208 cannot be inserted into the locking pin slot 215 and thus remains in a withdrawn (unlocked) position. When the locking pin 208 is not inserted into the locking pin slot 215, the door lock slider 112 is in a free state and can very easily slide.

FIGS. 3A-3C are structural schematic diagrams of the door lock box 204. FIG. 3A is a perspective view of the door lock box 204, in which the door lock box upper cover 214 of the door lock box 204 is hidden to show more components inside the door lock box 204. FIG. 3B is a partial enlarged perspective view of a circled part A of the door lock slider 112 shown in FIG. 3A, where part of a material of an outer side of the door lock slider 112 is hidden in FIG. 3B to more clearly show a slider recess 308 and a slider rack 304 of the door lock slider 112, and a cooperation relationship between the door lock slider 112 and the coil spring 232. FIG. 3C is an exploded mounting view of the door lock box 204 shown in FIG. 3A to show a mounting relationship between various components inside the door lock box 204.

As shown in FIGS. 3A and 3B, the door lock slider 112 has a slider body 301 and the slider recess 308 (see FIG. 3B) formed in an inner side of the slider body 301 in a length direction of the slider body 301. The slider rack 304 is disposed at one side of the slider recess 308 and has slider rack teeth 305. F or those of ordinary skill in the art, slider racks may also be provided on each of opposite sides of the slider recess 308.

Still referring to FIGS. 3A and 3B, a slider gear 302 is provided inside the door lock box 204 and is mounted in the slider recess 308. Slider gear teeth 306 are provided on an upper portion of the slider gear 302, and a lower portion of the slider gear 302 is fixed in the center of the coil spring 232. The slider gear 302 and the coil spring 232 have the same coil spring rotation axis 314. Therefore, when the slider gear 302 rotates clockwise, the slider gear 302 causes the coil spring 232 to start gradual outward elastic torsion from the center of the coil spring, such that elastic potential energy can be stored in the coil spring 232. The slider gear 302 can be engaged with the slider rack teeth 305 of the slider rack 304 by means of the slider gear teeth 306 to form a gear-rack transmission structure. Therefore, the rotation of the slider gear 302 around the coil spring rotation axis 314 can cause the slider rack 304 to move linearly, and the linear movement of the slider rack 304 can cause the slider gear 302 to rotate around the coil spring rotation axis 314.

Still referring to FIGS. 3A and 3B, the coil spring 232 is formed by coiling a continuous sheet metal material. A slider gear fixing portion 322 (see FIG. 3C for details) is disposed at a start end of a coil (i.e., the center of the coil spring 232), and is configured to be fixedly connected at a lower end of the slider gear 302, and an outer tail end 316 of the coil spring 232 is fixed to the coil spring fixing portion 318 on the door lock box housing 216. When the slider gear 302 rotates, the slider gear 302 causes a start end of the coil spring 232 to start to coil by means of the connection between the lower end of the slider gear 302 and the slider gear fixing portion 322. Since the tail end 316 of the coil spring 232 is fixed at the coil spring fixing portion 318 of the door lock box housing 216, the entire coil spring 232 does not rotate, but only torsional deformation occurs inside the coil spring 232 to store the elastic potential energy.

As shown in FIG. 3C, the coil spring 232 is disposed in a coil spring mounting recess 324 of the door lock box housing 216, such that the coil spring 232 can be twisted in a space defined by the coil spring mounting recess 324. The door lock slider 112 is disposed in a sliding groove 312 of the door lock box housing 216, such that the door lock slider 112 can be accommodated in the sliding groove 312 and linearly move leftward or rightward in a length direction of the sliding groove. Specifically, the door lock slider 112, the slider gear 302, the coil spring 232 and the door lock box housing 216 are sequentially placed in a vertical direction, and FIG. 3C shows a mounting relationship between these four components in the vertical direction. Similarly, the locking pin coil 209, the locking pin spring 207 and the locking pin 208 are sequentially placed in a front-rear direction, and FIG. 3C shows a mounting relationship between these three components in the front-rear direction.

It should be noted that an acting area at which the slider gear 302 drives the door lock slider 112 coincides or substantially coincides with a movement path of the door lock slider 112, and a rotation axis (i.e., the coil spring rotation axis 314) of the slider gear 302 is at a middle line in the length direction of the door lock slider 112. Specifically, the acting area where the slider gear teeth 306 of the slider gear 302 are engaged with the slider rack teeth 305 of the door lock slider 112 is located inside the slider body 301 of the door lock slider 112. Such an arrangement allows the slider gear 302 to drive the door lock slider 112 to move with a minimum force or torque.

FIGS. 4A-4C illustrate a structure and a schematic control chart of the driving assembly 202. FIG. 4A is an enlarged view of the driving assembly 202, with the driving device upper cover 222 of the driving assembly 202 hidden to show more components inside the driving assembly 202. FIG. 4B is an exploded mounting view of the driving assembly 202 shown in FIG. 4A to show a mounting relationship between various components inside the driving assembly 202. FIG. 4C is a block diagram of connection and control of the driving motor 226.

As shown in FIGS. 4A and 4B, the driving assembly 202 includes the driving gear 220, the driving rack 228, a gear transmission component 406, and the driving motor 226. The driving gear 220, the driving rack 228 and the gear transmission component 406 are disposed inside the driving device housing 224 of the driving assembly 202, and the driving motor 226 is partially disposed outside the driving device housing 224. In FIG. 4B, the driving gear 220 or the driving rack 228, the gear transmission component 406, the driving motor 226 and the driving device housing 224 are vertically placed, and FIG. 4B shows the vertical assembly relationship between these components.

Specifically, the driving device housing 224 has a driving gear accommodating cavity 422 for accommodating the driving gear 220 such that the driving gear 220 is limited to rotate inside the driving gear accommodating cavity 422. The driving device housing 224 further has a driving rack sliding groove 424, such that the driving rack 228 can be accommodated in the driving rack sliding groove 424 and linearly reciprocate in a length direction of the driving rack sliding groove.

The driving motor 226 has a driving motor output shaft 408, and the driving motor output shaft 408 is cooperatively connected to the driving gear 220 by means of the gear transmission component 406, so as to drive the driving gear 220 to rotate. The driving gear 220 has driving gear outer teeth 416, and driving rack teeth 412 are provided on an upper side of the driving rack 228 and can be engaged with the driving gear outer teeth 416 of the driving gear 220, such that forward and reverse rotations of the driving motor 226 can cause the driving rack 228 to reciprocate in the driving rack sliding groove 424. The driving motor 226 further has positive and negative plugs 434, 436, and the positive and negative plugs 434, 436 can be electrically connected to a drive circuit 442 and an external power supply (see FIG. 4C) to provide power for the rotation of the driving motor 226 and to control a direction of rotation of the driving motor 226.

Specifically, as shown in FIG. 4C, the positive and negative plugs 434, 436 of the driving motor 226 are connected to the drive circuit 442. In an embodiment of the present disclosure, the drive circuit 442 may be a motor driving module or a relay. The current detection component 445/446 is connected to the drive circuit 442 and the control device 160, and in an embodiment of the present disclosure, only one current detection component 445/446 may be provided. For example, only the current detection component 446 is provided and the current detection component 446 is connected to the control device 160 by means of a connecting line 462. The current detection component 445/446 includes a current detection module and component(s) for performing amplification and other processing operations on the circuit. The current detection component 445/446 may also include only a current detection module. The current detection module of the current detection component 445/446 is connected to a positive or negative pole of the power supply. The control device 160 may generate a motor control signal based on an analog signal received by the current detection component 446, to control the drive circuit 442 by means of a control line 456, so as to control the rotation or stop and the forward or reverse rotation of the driving motor 226.

If there is an interfering obstacle during closing the door of the dishwasher 100, due to an increase in a resistance to door closing, a current flowing through the driving motor 226 continuously increase to cope with this resistance. An upper limit threshold of a current may be set in advance in a control program, and this upper limit threshold is greater than a current during a normal operation. Once the current of the motor exceeds this upper limit threshold, the control device 160 can identify by means of the current detection component 445/446 that there is an obstacle in the door gap 111 of the dishwasher 100, and thus control to stop the rotation or reverse the rotation of the motor to stop closing the door so as to allow to remove the obstacle.

A movement operation process of the door lock slider 112 and the driving rack 228 will be described below with reference to FIGS. 3A-4B.

During the movement of the door lock slider 112 from the retracted position to the extended position, at a starting stage, the control device 160 sends a pulse signal to the locking pin coil 209 to generate an electromagnetic actuating force on the locking pin 208, such that the locking pin 208 is withdrawn from the locking pin slot 215 of the door lock slider 112 by overcoming the elastic force of the locking pin spring 207, so as to unlock the door lock slider 112. Under the control of the control device 160, the driving motor 128 rotates forward to drive the driving rack 228 to linearly move leftward by means of the driving gear 220. Since the leftward movement of the driving rack 228 releases a pull force on the rope 206, the rope 206 no longer pulls the door lock slider 112, the coil spring 232 can release the elastic potential energy stored therein to cause the slider gear 302 to rotate counterclockwise, and the counterclockwise rotation of the slider gear 302 causes the door lock slider 112 to linearly move leftward in the sliding groove 312 by means of the slider rack 304 meshing with the slider gear.

Conversely, during the movement of the door lock slider 112 from the extended position to the retracted position, under the control of the control device 160, the driving motor 128 rotates reversely to cause the driving rack 228 to linearly move rightward by means of the driving gear 220. The rope 206 can be pulled by means of the rightward linear movement of the driving rack 228, and thus the door lock slider 112 is pulled to linearly move rightward in the sliding groove 312. The rightward linear movement of the door lock slider 112 causes, by means of the slider rack 304, the clockwise rotation of the slider gear 302 meshing with the slider rack, and the clockwise rotation of the slider gear 302 can cause the torsion of the coil spring 232 and the storage of the elastic potential energy in the coil spring. When the door lock slider 112 moves to the retracted position, the locking pin slot 215 is aligned with the locking pin 208 in position, such that the locking pin 208 can be inserted (sprung) into the locking pin slot 215 under the action of the locking pin spring 207, so as to lock the door lock slider 112 in the retracted position.

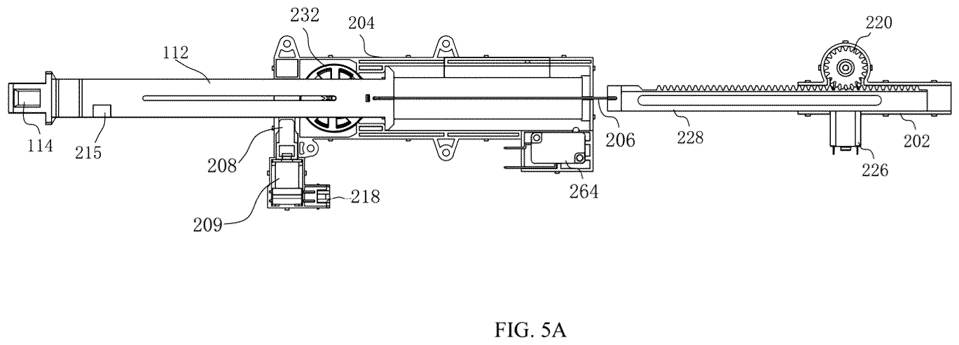

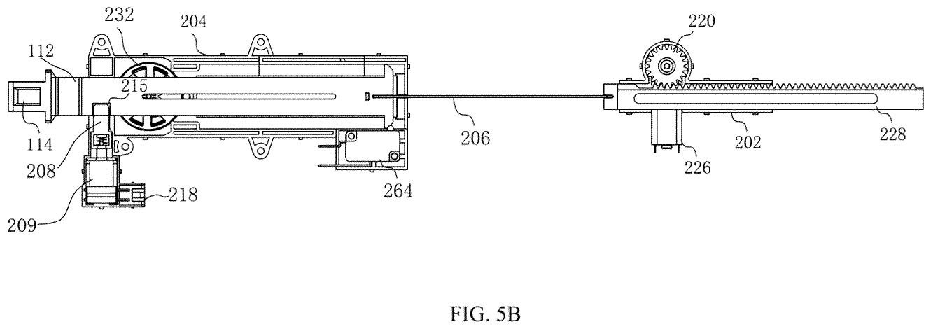

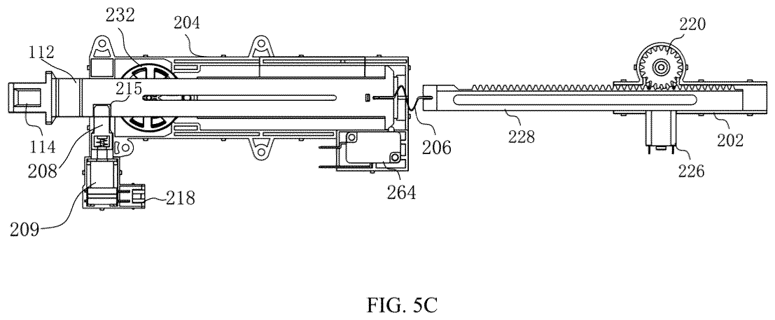

FIGS. 5A-5C show schematic diagrams of the door lock slider 112 moving between the extended position and the retracted position. FIG. 5A is a schematic diagram of the door lock slider 112 in the extended position; FIG. 5B is a schematic diagram of the door lock slider 112 in the retracted position; and FIG. 5C is a schematic diagram of the door lock slider 112 that is forced back from the extended position to the retracted position.

As shown in FIGS. 5A-5C, when the dishwasher 100 performs a heat dissipation operation, the dishwasher door 106 is in the heat dissipation position (corresponding to a state as shown in FIG. 1C), the door lock slider 112 is in the extended position at this moment, and the door hook 108 remains engaged with the door hook hole 114 of the door lock slider 112 (not shown). After the heat dissipation operation of the dishwasher 100 is completed, in order to close the dishwasher door 106, the control device 160 controls to pull the door lock slider 112 to move from the extended position as shown in FIG. 5A to the retracted position as shown in FIG. 5B by controlling the driving rack 228, and at this moment, the door hook 108 remains engaged with the door hook hole 114 of the door lock slider 112 (corresponding to a state shown in FIG. 1B). If the user forces the door to close in the state as shown in FIG. 5A, the door lock slider 112 is forced back to the retracted position under the action of a push force on the door, instead of moving to the retracted position under the control of the control device 160. Since the door lock slider 112 is flexibly connected to the driving rack 228 by means of the rope 206, after the door lock slider 112 is forced back to the retracted position under the action of the push force on the door, the driving rack 228 still remains in a position corresponding to the extended position of the door lock slider 112 without reset, as shown in FIG. 5C, and in this case, after the positioning switch 264 detects that the door lock slider 112 is in the retracted position, the control device 160 controls the driving rack 228 to be reset in the state shown in FIG. 5B. If the user pulls the door latch handle 105 to open the dishwasher door 106 in the heat dissipation position of the dishwasher door 106 shown in FIG. 5A, the door hook 108 is disengaged from the door hook hole 114 of the door lock slider 112, the dishwasher door 106 is moved to the open position, and the control device 160 controls the driving rack 228 to pull the door lock slider 112 to move from the extended position shown in FIG. 5A to the retracted position shown in FIG. 5B. If the user pulls the door latch handle 105 to open the dishwasher door 106 in the closed position of the dishwasher door 106 shown in FIG. 5B, the door hook 108 is disengaged from the door hook hole 114 of the door lock slider 112, and the door lock device 110 remains in the state shown in FIG. 5B (corresponding to the state as shown in FIG. 1A).

If the dishwasher 100 is unexpectedly powered off in the state as shown in FIG. 5A, the control device 160 cannot control the door to be closed. In this case, if the user forcedly closes the door, the door lock slider 112 is forced back to the retracted position shown in FIG. 5C under the action of the push force, and the locking pin 208 can be inserted (sprung) into the locking pin slot 215 under the action of the locking pin spring, so as to lock the door lock slider 112 in the retracted position. Since the door lock slider 112 is flexibly connected to the driving rack 228 by means of the rope 206, the door lock slider 112 does not push the driving rack 228 to move during movement to the retracted position, that is, a rightward push force on the door lock slider 112 is not transmitted to the driving assembly 202 (the push force on the door lock slider 112 is isolated by the rope 206), and thus the rack 228, the gear 220 and the motor 226 of the driving assembly 202 remain unchanged in position and state to serve a function of protecting the driving assembly 202.

A control process for the door lock device 110 will be described in detail below.

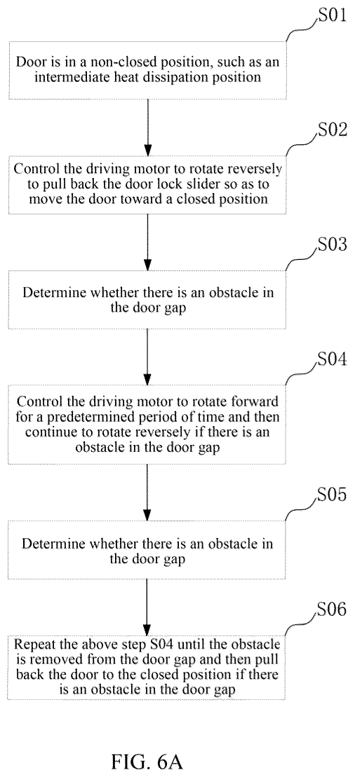

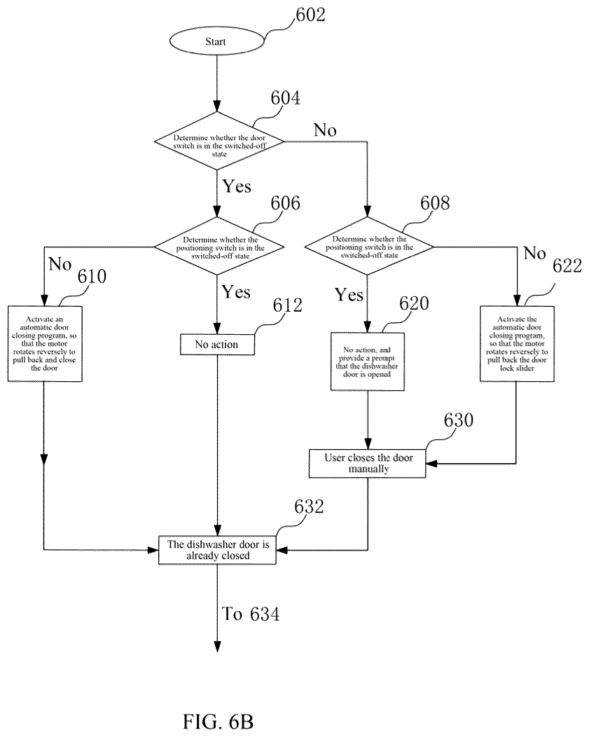

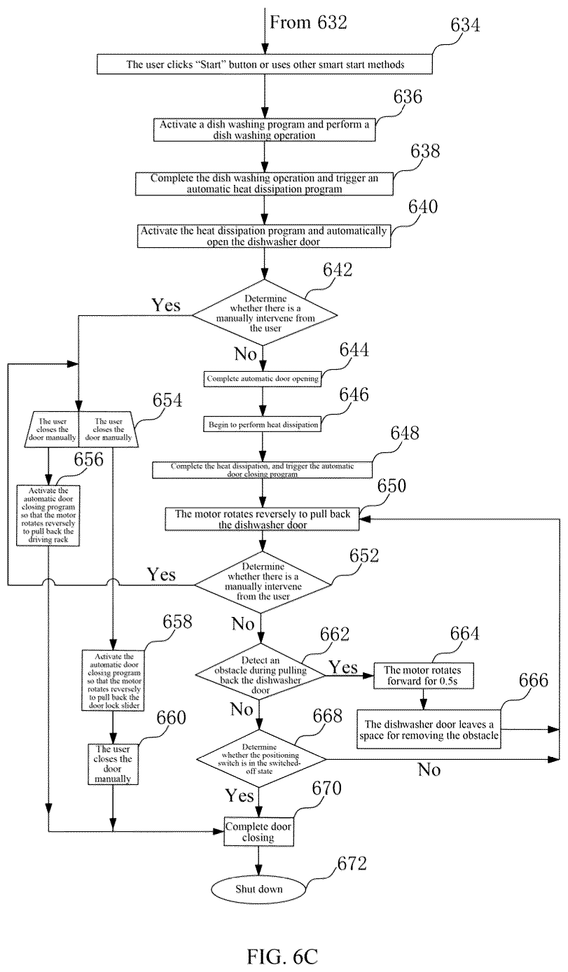

FIGS. 6A-6C show control flow charts of operations of the dishwasher 100. FIG. 6A is a control logic diagram of closing the dishwasher door; FIG. 6B shows a flow chart of a resetting process of the dishwasher door 106, that is, the dishwasher door 106 is moved to or remains in a closed state regardless of the state thereof; and FIG. 6C shows a flow chart of activating a dish washing program and a heat dissipation program after the resetting of the dishwasher door 106 is completed.

As shown in FIG. 6A, in steps S01 and S02, when the dishwasher door 106 is in the opened position or the intermediate position (the heat dissipation position) and needs to be closed, the control device 160 controls the driving motor 226 to rotate reversely (corresponding to a direction for closing the door), causing the door lock slider 112 to move from the extended position to the retracted position, so as to pull back the dishwasher door 106 to the closed position. In steps S03 and S04, it is determined whether there is an obstacle in the door gap during pulling back the dishwasher door 106 to the closed position, and if there is an obstacle, the control device 160 controls the driving motor 226 to rotate forward (corresponding to a direction for opening the door) for a predetermined period of time to ensure that the obstacle is removed from the door gap, and then controls the driving motor 226 to rotate reversely. In steps S05 and S06, it is again determined whether there is an obstacle in the door gap, and if there is an obstacle, the step S04 is repeated until the obstacle is removed from the door gap, and the door is then pulled back to the closed position.

FIGS. 6B and 6C show details of a specific control flow.

As shown in FIG. 6B, in step 602, it executes a reset operation program for the dishwasher door, and the control device 160 detects pulsed states of the door switch 260 and the positioning switch 264 in the following reset operation. Specifically, the door switch 260 and the positioning switch 264 each have two pulsed states, namely, a low-level state and a high-level state. For example, the low-level state of each of the door switch 260 and the positioning switch 264 indicates that the switch is in a switched-on state, and the high-level state indicates that the switch is in a switched-off state. Of course, those skilled in the art should understand that by means of rational circuit setting, the low-level state of each of the door switch 260 and the positioning switch 264 may also be indicative of the switch being in the switched-off state, and the high-level state may also be indicative of the switch being in the switched-on state. After the operation of step 602 is completed, the flow proceeds to step 604.

In step 604, it is determined whether the door switch 260 is in the switched-off state. If the door switch 260 is in the switched-off state, that is, the door hook hole in the door lock slider 112 is engaged with the door hook of the door, the flow proceeds to step 606; and if the door switch 260 is not in the switched-off state, that is, the door hook hole 114 in the door lock slider 112 is disengaged from the door hook 108, the flow proceeds to step 608.

In step 606, it is determined whether the positioning switch 264 is in the switched-off state. If the positioning switch 264 is in the switched-off state, that is, the door lock slider 112 is in the retracted position, the flow proceeds to step 612; and if the positioning switch 264 is not in the switched-off state, that is, the door lock slider 112 is not in the retracted position, the flow proceeds to step 610.

In step 608, it is determined whether the positioning switch 264 is in the switched-off state. If the positioning switch 264 is in the switched-off state, that is, the door lock slider 112 is in the retracted position, the flow proceeds to step 620; and if the positioning switch 264 is not in the switched-off state, that is, the door lock slider 112 is not in the retracted position, the flow proceeds to step 622.

In step 610, since the door hook hole 114 of the door lock slider 112 is engaged with the door hook 108 and the door lock slider 112 is not in the retracted position, that is, the dishwasher door 106 is pushed open with a gap by the door lock slider 112, the control device 160 activates an automatic door closing program, and the driving motor 226 rotates reversely to pull back the dishwasher door 106 to the closed position. After the operation of step 610 is completed, the flow proceeds to step 632.

In step 612, since the door hook hole 114 of the door lock slider 112 is engaged with the door hook 108 and the door lock slider 112 is in the retracted position, that is, the door is in the closed position, the control program does not perform any operation, and the door lock device does not perform any actions. After the operation of step 612 is completed, the flow proceeds to step 632.

In step 620, since the door hook hole 114 of the door lock slider 112 is disengaged from the door hook 108 and the door lock slider 112 is in the retracted position, that is, the door is in the open position (manually opened) and the door lock slider 112 is retracted, the control program does not perform any operation and only sends a prompt signal indicative of the dishwasher door 106 being opened to the user. After the operation of step 620 is completed, the flow proceeds to step 630.

In step 622, since the door hook hole 114 of the door lock slider 112 is disengaged from the door hook 108 and the door lock slider 112 is in the extended position, that is, the dishwasher door 106 is in the open position (manually opened) and the door lock slider 112 is not retracted, the control device 160 activates the automatic door closing program, and the driving motor 226 rotates reversely to pull back the door lock slider 112 to the retracted position. After the operation of step 622 is completed, the flow proceeds to step 630.

In step 630, since the dishwasher door is still in the open position (manually opened) and the door hook 108 is disengaged from the door lock slider 112, the door cannot be closed by means of the driving motor 226 driving the door lock slider 112, and the user needs to manually close the door. After the operation of step 630 is completed, the flow proceeds to step 632.

In step 632, the control device 160 completes the reset operation program, the dishwasher door 106 has been closed, and the flow proceeds to step 634.

As shown in FIG. 6C, in step 634, a dish washing program and a heat dissipation program can be activated for the dishwasher after the reset operation program is completed. The user can activate the dish washing program by clicking a “Start” button on a user interaction panel of the dishwasher, or by means of another smart start method (e.g., the control program). After the operation of step 634 is completed, the flow proceeds to step 636.

In step 636, the dish washing program is activated, and a dish washing operation begins. After the operation of step 636 is completed, the flow proceeds to step 638.

In step 638, after the dish washing operation is completed, an automatic heat dissipation program is triggered. After the operation of step 638 is completed, the flow proceeds to step 640.

In step 640, the heat dissipation program begins, the control device 160 controls the door lock slider 112 to move from the retracted position to the extended position, and the dishwasher door 106 is automatically opened. After the operation of step 640 is completed, the flow proceeds to step 642.

In step 642, it is determined whether there is a manual intervention from the user during automatic opening of the dishwasher door 106. If there is a manual intervention from the user, the flow proceeds to step 654; and if there is no manual intervention from the user, the flow proceeds to step 644.

In step 654, it is determined whether the manual intervention from the user is manual door opening or manual door closing. If the user manually open the door, that is, the door hook hole 114 in the door lock slider 112 is disengaged from the door hook 108, the door switch 260 changes from the switched-off state to the switched-on state, and the flow proceeds to step 658; and if the user manually closes the door, the door lock slider 112 is pushed to the retracted position, the positioning switch 264 changes from the switched-on state to the switched-off state, and the flow proceeds to step 656.

In step 656, since the dishwasher door 106 is manually closed by the user, it may indicate that the user does not wish to perform the heat dissipation operation. In this case, the door lock slider 112 is pushed to the retracted position by a push force of the user manually pushing the door, and the push force acting on the door lock slider 112 is blocked by the flexible rope 206, so that the driving rack 228 remains unchanged in position (refer to the state as shown in FIG. 5C), and thus the control device 160 needs to activate the automatic door closing program such that the driving motor 226 rotates reversely to pull back the driving rack 228. After the operation of step 656 is completed, the flow proceeds to step 670.

In step 658, since the dishwasher door 106 is already manually pulled open and the door lock slider 112 is still in the extended position or in a position between the retracted position and the extended position, the control device 160 activates the automatic door closing program such that the driving motor 226 rotates reversely to pull back the door lock slider 112. After the operation of step 658 is completed, the flow proceeds to step 660.

In step 660, since the dishwasher door 106 is still in an open state, the user needs to manually close the dishwasher door 106 after the heat dissipation program ends. After the operation of step 660 is completed, the flow proceeds to step 670.

In step 644, if there is no manual intervention from the user, the control device 160 controls the door lock slider 112 to move from the retracted position to the extended position, and the dishwasher door 106 is automatically opened to the heat dissipation position. After the operation of step 644 is completed, the flow proceeds to step 646.

In step 646, after the dishwasher door 106 is automatically opened to the heat dissipation position, the heat dissipation program is activated, and the dishwasher begins to dissipate heat. After the operation of step 646 is completed, the flow proceeds to step 648.

In step 648, after the heat dissipation program ends, the automatic door closing program of the dishwasher is triggered. After the operation of step 648 is completed, the flow proceeds to step 650.

In step 650, the control device 160 controls the driving motor 226 to rotate reversely (corresponding to the direction for closing the door), causing the door lock slider 112 to move from the extended position to the retracted position, so as to pull back the dishwasher door 106 from the heat dissipation position to the closed position. After the operation of step 650 is completed, the flow proceeds to step 652.

In step 652, it is determined whether there is a manual intervention from the user during automatically pulling back the dishwasher door 106. If there is a manual intervention from the user, the flow proceeds to step 654, and the above-mentioned steps are repeated; and if there is no manual intervention from the user, the flow proceeds to step 662.

In step 662, it is determined whether an obstacle is detected in the door gap 111 of the dishwasher 100 during automatically pulling back the dishwasher door 106. If no obstacle is detected, the flow proceeds to step 668; and if an obstacle is detected, the flow proceeds to step 664.

In step 664, since it is detected that there is an obstacle in the door gap 111 of the dishwasher 100, in order to ensure that the obstacle can be removed, the control device 160 controls the driving motor 226 to rotate forward (corresponding to the direction for opening the door) for 0.5 seconds or controls the driving motor 226 to stop rotating for 0.5 seconds. After the operation of step 664 is completed, the flow proceeds to step 666.

In step 666, the driving motor 226 rotates forward such that the dishwasher door 106 can leave a certain space for removing the obstacle. After the operation of step 666 is completed, the flow proceeds to step 650, and the above steps are repeated.

In step 668, it is determined whether the positioning switch 264 is in the switched-off state. If the positioning switch 264 is in the switched-off state, that is, the door lock slider 112 is pulled back to the retracted position and the dishwasher door 106 is accordingly pulled back to the closed position by the door lock slider 112, the flow proceeds to step 670; and if the positioning switch 264 is not in the switched-off state, that is, the door lock slider 112 is not yet pulled back to the retracted position and the dishwasher door 106 is accordingly not yet pulled back to the closed position, the flow proceeds to step 650, and the above steps are repeated.

In step 670, the dishwasher door 106 is pulled back to the closed position by the door lock slider 112, the door closing operation is completed, the flow proceeds to step 672, and the control program ends and the dishwasher is shut down.

FIGS. 7A-7D are block diagrams of two embodiments of the control device 160 of the present disclosure, which show specific components and connection relationships of the control device 160. The control device 160 can store and execute the programs of the dishwasher control flow as shown in FIGS. 6A-6C, and store and call various parameters required for the control flow. The difference between FIG. 7A and FIG. 7D is that different obstacle detection components are selected and arranged in the door lock device 110. The obstacle detection component in FIG. 7A is the current detection component 445, and it can be determined whether there is an obstacle in the door gap 111 by directly detecting a current change of the driving motor 226. FIG. 7B is a circuit diagram of a motor control part of the control device shown in FIG. 7A, and FIG. 7C is a circuit diagram of a switching signal and door opening operation signal control part of the control device shown in FIG. 7A. The obstacle detection component in FIG. 7D is the obstacle sensor 150, such as an infrared sensor, a photoelectric (photosensitive) sensor or a capacitive sensor, and it is determined whether there is an obstacle in the door gap 111 by detecting a change in an infrared signal, a photoelectric signal or a capacitive signal.

As shown in FIGS. 7A-7D, the control device 160 includes a bus 702, a processor 704, a memory 706, an input interface 708 and an output interface 710. The processor 704, the memory 706, the input interface 708 and the output interface 710 are connected to the bus 702. The processor 704 is configured to read program(s) (or instruction(s)) from the memory 706 and execute the program(s) (or the instruction(s)) to process data. The processor 704 is further configured to write data or program(s) (or instruction(s)) into the memory 706. The memory 706 is configured to store the program(s) (the instruction(s)) or the data. By executing the instruction in the memory 706, the processor 704 can control the memory 706, the input interface 708 and the output interface 710. In the present disclosure, the processor 704 can execute the dishwasher control programs of the flow shown in FIGS. 6A-6C and store operating parameters required for executing the programs.

The input interface 708 is configured to acquire and receive an obstacle signal fed back by the obstacle detection component (the current detection component 446 or the obstacle sensor 150), a user input signal, the pulse signal (high-level or low-level state) of the door switch 260 and the pulse signal (high-level or low-level state) of the positioning switch 264 by means of the connecting line 462 or 152, 714, 716, 718, and to convert these signal data into signals identifiable by the processor 704 and store the same in the memory 706.

The processor 704 is configured to execute the programs stored in the memory 706 based on the acquired signals, generate a control signal for the driving motor 226 or a system prompt signal based on instruction(s) of the control programs, and send the generated signal(s) to the output interface 710. The output interface 710 is configured to receive a motor control signal from the processor 704 and transmit the motor control signal to the driving motor 226 by means of the control line 456 so as to control the forward rotation, reverse rotation or stop of the driving motor 226. When the dishwasher 100 performs the automatic door opening operation, the output interface 710 receives a door opening operation signal from the processor 704 and transmits the door opening operation signal to the locking pin coil 209 shown in FIGS. 2D and 2E by means of a connecting line 722, such that the locking pin coil 209 actuates the locking pin 208 to move close to the locking pin coil 209, the locking pin is thus withdrawn from the locking pin slot 215 of the door lock slider 112 so as to unlock and release the door lock slider 112, allowing the door lock slider 112 to move toward the extended position. The output interface 710 is further configured to receive the system prompt signal from the processor 704 and transmit the system prompt signal to the user interaction panel of the dishwasher 100 by means of a connecting line 723, display a visual signal to the user by means of a visual screen of the user interaction panel, or send an audio signal to the user by means of an audio play device of the user interaction panel of the dishwasher, so as to prompt the user to perform a corresponding operation.

FIG. 7B and FIG. 7C are diagrams of specific control circuits of input and output parts of the control device 160 shown in FIG. 7A, respectively.

As shown in FIG. 7B, the drive circuit 442 is a chip for driving the motor 226, and a chip model TB67H450 is used in an embodiment of the present disclosure. As it is known to those skilled in the art, other chip models on the market may also be used, and the present disclosure is not limited to the chip model used in this embodiment. In an embodiment of the present disclosure, the drive circuit 442 has eight pins, wherein a pin 1 is a grounding pin (GND); a pin 2 is a first input pin (IN1) connected to a first output 731 of the output interface 710 and configured to receive a control signal; a pin 3 is a second input pin (IN2) connected to a second output 732 of the output interface 710 and configured to receive a control signal; a pin 4 is a motor output current setting pin configured to set a maximum output current (a protective current) of the motor; a pin 5 is a motor power supply pin configured to provide power (e.g., a power supply of +12 V) to the driving motor 226; a pin 6 is a first output pin (OUT1) connected to the positive/negative plug 434 of the motor and configured to control the rotation of the motor; a pin 7 is a motor output current detection pin configured to detect an output current of the motor (a motor sampling current); and a pin 8 is a second output pin (OUT2) connected to the positive/negative plug 436 of the motor and configured to control the rotation of the motor.

The first output 731 and the second output 732 of the output interface 710 output digital signals indicating a low-level state or a high-level state. The first output 731 and the second output 732 can output four different combinations for the signals according to the permutation and combination principle, that is, the drive circuit 442 can receive four kinds of control signals, i.e., “low-low” signal, “high-low” signal, “low-high” signal and “high-high” signal, wherein the “low-low” signal is configured to control the motor to stop rotating, the “high-low” signal is configured to control the motor to rotate forward, the “low-high” signal is configured to control the motor to rotate reversely, and the “high-high” signal is configured to control the braking of the motor. The signals and motor control modes respectively corresponding to the pin 2 (IN1), the pin 3 (IN2), the pin 6 (OUT1) and the pin 8 (OUT2) of the drive circuit 442 are shown in Table 1 below. In an embodiment of the present disclosure, only the three control signals, i.e., “low-low” signal, “high-low” signal and “low-high” signal, are used and are configured to respectively control the driving motor 226 to stop rotating, to rotate forward and to rotate reversely.

| IN1 | IN2 | OUT1 | OUT2 | Motor control mode |
|---|---|---|---|---|
| L | L | OFF | OFF | Stop rotating |
| H | L | H | L | Forward rotation |
| L | H | L | H | Reverse rotation |
| H | H | L | L | Braking |

Still as shown in FIG. 7B, the current detection component 446 is connected to the pin 7 of the drive circuit 442 and includes circuit connections and corresponding components as illustrated, wherein capacitors C1 and C2 are configured for filtering, R3 represents a current sampling resistance, and four resistances R4, R5, R6, R7 collectively determine the amplification of an operational amplifier U7, and a voltage signal output from the operational amplifier U7 is transmitted to the input interface 708 by means of the connecting line 462. A voltage comparison threshold is stored in the control device 160. When the voltage signal input by the connecting line 462 is higher than the voltage comparison threshold, it is determined that there is an obstacle in the door gap, the control device 160 outputs the “high-low” signal to the drive circuit 442 to control the motor to rotate forward. When the voltage signal input by the connecting line 462 is not higher than the voltage comparison threshold, it is determined that there is no obstacle in the door gap, the control device 160 outputs the “low-high” signal to the drive circuit 442 to control the motor to rotate reversely.

As shown in FIG. 7C, when the door switch 260 is switched off, the connecting line 716 inputs a voltage of +5 V to the input interface 708, and when the door switch 260 is switched on, short circuiting occurs, and the connecting line 716 inputs a voltage of 0 V to the input interface 708. Similarly, when the positioning switch 264 is switched off, the connecting line 718 inputs a voltage of +5 V to the input interface 708, and when the positioning switch 264 is switched on, short circuiting occurs, and the connecting line 718 inputs a voltage of 0 V to the input interface 708.

Still as shown in FIG. 7C, the output interface 710 outputs a digital signal by means of the connecting line 722, indicating the high-level state or the low-level state. When the connecting line 722 outputs a high level, a triode Q1 is powered on, a relay switch 734 is switched on, the locking pin coil 209 is powered on, and an electromagnetic force is generated to pull back the locking pin 208 to the non-locked position as shown in FIG. 2E. When the connecting line 722 outputs a low level, the triode Q1 is not powered on, the relay switch 734 is switched off, the locking pin coil 209 is not powered on, and the locking pin 208 can be automatically inserted into the locking pin slot 215 of the door lock slider 112 under the action of the locking pin spring 207 so as to lock the door lock slider 112.

The door lock device of the present disclosure can achieve at least the following beneficial technical effects.

First, in the automatic door closing process of the dishwasher, if there is an obstacle in the door gap, for example, a user accidentally reaches his/her hand into the door gap, the driving motor can stop driving the door lock slider to move toward the retracted position or allow the door lock slider to move toward the extended position, thus stopping the door closing or re-opening the door, so as to prevent the obstacle from being clamped.

Second, the door lock assembly of the door lock device of the present disclosure can be connected to the driving device by means of the flexible rope, so that the relative positions of the door lock assembly and the driving device of the door lock device are freer to arrange. Rational relative position arrangement of the door lock assembly and the driving device can make full use of a narrow and small space of an electrical apparatus, that is, the position arrangement of the driving device is not limited by the position of the door lock assembly. By means of the rational structural arrangement, the door lock assembly and the driving device can be mounted in two housings of the electrical apparatus, respectively.

Third, the door lock assembly of the door lock device of the disclosure can be connected to the driving device by means of the flexible rope, so that only the pull force can be transmitted and the push force can be isolated by means of the connection with the flexible rope. If a user forces the door to the closed position when the dishwasher door is not closed, the push force generated by the movement of the door lock slider toward the retracted position (the closed position) is not transmitted to the driving device, and thus the motor is not adversely affected.

Fourth, during executing the heat dissipation program of the dishwasher, even if a user manually intervenes the door opening or closing operation, the control system has a set of corresponding response programs, so that the normal operation control of the (heat dissipation) program of the dishwasher is not affected, and thus the door lock slider is not separately exposed to the outside of the dishwasher, or the driving motor does not reset the driving rack to affect a next automatic door opening operation.

Fifth, in the door lock device of the present disclosure, the axis of rotation of the biasing device passes through the center of a movement path of the door lock slider, so that the biasing force of the biasing device on the door lock slider is more uniform, and the biasing force does not generate an excess torque on the door lock slider. Therefore, the position arrangement of the biasing device in the present disclosure is more rational, the door lock slider can be caused to move with a relatively small biasing force generated by the biasing device, so that the apparatus door can be driven to and for with a relatively small force, and requirements on the elastic force provided by the biasing device (such as the coil spring) are relatively low.

Although the present disclosure is described in conjunction with the examples of embodiments outlined above, various alternatives, modifications, variations, improvements, and/or substantial equivalents that are known or current or to be anticipated before long may be obvious to those of at least ordinary skill in the art. In addition, the technical effects and/or technical problems described in the present disclosure are exemplary rather than restrictive. Therefore, the disclosed description in the present disclosure may be used to solve other technical problems and have other technical effects and/or can solve other technical problems. Accordingly, the examples of the embodiments of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or substantial equivalents.

1. A control method for controlling a motor (226) of a door lock device (110), the motor (226) being configured to drive a door lock slider (112) to move, and the door lock slider (112) being configured to actuate a door (106) of an electrical apparatus, the control method comprising:
S01, controlling the motor (226) to rotate in a first direction of rotation to allow the door lock slider (112) to retract so as to move the door (106) toward a closed position if the door (106) is in a non-closed position;
S02, determining whether there is an obstacle in a gap (111) with which the door (106) is opened in the process of the door (106) moving toward the closed position; controlling the motor (226) to rotate in a second direction of rotation opposite the first direction of rotation for a first predetermined period of time if there is an obstacle in the gap (111), and controlling the motor (226) to rotate in the first direction of rotation after the first predetermined period of time ends; and repeating the aforementioned operations in step S02 until the obstacle is removed from the gap (111); and
S03, moving the door (106) to the closed position.

2. The control method of claim 1, wherein:
in step S01, performing the following steps if there is a manual intervention:
S01-1, controlling the motor (226) to rotate in the first direction of rotation to allow the door lock slider (112) to retract if the manual intervention is manual door opening and the door lock slider (112) is disconnected from the door (106); performing a manual door closing operation after the door (106) is kept in an open position for a period of time, and proceeding to step S03 after the manual door closing operation is completed; or
S01-2, controlling the motor (226) to rotate in the first direction of rotation if the manual intervention is manual door closing, and proceeding to step S03 after the manual door closing operation is completed.

3. The control method of claim 1, wherein
in step S02, whether there is an obstacle in the gap (111) is determined by measuring a current change of the motor (226).

4. The control method of claim 1, wherein
in step S02, whether there is an obstacle in the gap (111) is determined by measuring a change of infrared signal, photoelectric signal or capacitive signal in the gap (111).

5. The control method of claim 1, wherein
the control method further comprises the following steps prior to step S01:
S011, closing the door (106), and performing a dish washing operation with the door (106) in the closed position, and at this time, the door lock slider (112) being in a retracted position and connected to the door (106); and
S012, controlling the motor (226) to rotate in the second direction of rotation to allow the door lock slider (112) to extend out, so as to move the door (106) toward a predetermined position; and
S013, opening the door (106) with the gap (111) and keeping the door (106) for a second predetermined period of time in a state of being opened with the gap (111) when the door (106) is in the predetermined position, the door lock slider (112) being in an extended position and keeping in connection with the door (106); and proceeding to step S01 after the second predetermined period of time ends.

6. The control method of claim 5, wherein
the electrical apparatus performs a heat dissipation operation within the second predetermined period of time.

7. The control method of claim 1, wherein
in step S02, controlling the motor (226) to continue to rotate in the first direction of rotation and proceeding to step S03 if there is no obstacle in the gap (111) or if the obstacle is removed from the gap (111).

8. The control method of claim 5, wherein
in step S012, performing the following steps if there is a manual intervention:
S012-1, controlling the motor (226) to rotate in the first direction of rotation to allow the door lock slider (112) to retract if the manual intervention is manual door opening and the door lock slider (112) is disconnected from the door (106); and performing a manual door closing operation after the door (106) is kept in an open position for a period of time, and proceeding to step S03 after the manual door closing operation is completed; or
S012-2, controlling the motor (226) to rotate in the first direction of rotation if the manual intervention is manual door closing, and proceeding to step S03 after the manual door closing operation is completed.

9. A door lock device (110), comprising a motor (226), a door lock slider (112), an obstacle detection component and a control device (160), the control device (160) being configured to control the rotation of the motor (226), the motor (226) being configured to drive the door lock slider (112) to move, and the door lock slider (112) being configured to actuate a door (106) of an electrical apparatus, wherein
the door lock device (110) is configured to open or close the door (106) by the control method of claim 1.

10. A door lock device (110) for opening and closing a door (106) of an electrical apparatus, the door lock device (110) comprising:
a door lock assembly (204) configured to actuate the door (106), the door lock assembly (204) comprising a door lock slider (112) having an extended position and a retracted position;
a driving assembly (202) connected with the door lock slider (112) for allowing the door lock slider (112) to reciprocate between the extended position and the retracted position;
an obstacle detection component (445, 446, 150) configured to detect whether there is an obstacle in a gap (111) with which the door (106) is opened; and
a control device (160) configured to control the driving assembly (202) based on a detection result from the obstacle detection component (445, 446, 150);
wherein the control device (160) is configured to control the driving assembly (202) to allow the door lock slider (112) to move to the extended position, so as to allow the door (106) to move in a direction opposite a closed position when the door lock slider (112) drives the door (106) to move to the closed position and the obstacle detection component (445, 446, 150) detects that there is an obstacle in the gap (111) with which the door (106) is opened.

11. The door lock device of claim 10, further comprising:
a driving motor (226) configured to drive the driving assembly (202), wherein the control device (160) is configured to control a rotation direction of the driving motor (226) so as to control a movement of the driving assembly (202).

12. The door lock device of claim 11, wherein
the obstacle detection component (445, 446, 150) is a current detection component (445, 446) for detecting a current passing through the driving motor (226).

13. The door lock device of claim 11, wherein
the obstacle detection component (445, 446, 150) is a photosensitive detection component, an infrared detection component or a capacitive detection component for detecting whether there is an obstacle in the gap (111) with which the door (106) is opened.

14. The door lock device of claim 11, wherein the door lock assembly (204) further comprises a positioning switch (264) and a door switch (260),
wherein the control device (160) is configured to control a rotation of the driving motor (226) based on states of the positioning switch (264) and the door switch (260),
wherein the positioning switch (264) is switched off when the door lock slider (112) is in the retracted position, and the positioning switch (264) is switched on when the door lock slider (112) is not in the retracted position; and
wherein the door switch (260) is switched off when a door hook of the door (106) is engaged with the door lock slider (112), and the door switch (260) is switched on when the door hook of the door (106) is disengaged from the door lock slider (112).

15. The door lock device of claim 14,
wherein the door (106) has an open position, the closed position and one or more intermediate positions between the open position and the closed position,
wherein when the door (106) is in the closed position, the door lock slider (112) is in the retracted position, the positioning switch (264) is switched off, and the door switch (260) is switched off;
wherein when the door (106) is in the one or more intermediate positions, the door lock slider (112) is in the extended position, the positioning switch (264) is switched on, and the door switch (260) is switched off; and
wherein when the door (106) is in the open position, the door lock slider (112) is in the retracted position, the positioning switch (264) is switched off, and the door switch (260) is switched on.

16. The door lock device of claim 10, wherein the driving assembly (202) comprises:
a driving gear (220) configured to be rotatable in a first direction of rotation or a second direction of rotation; and
a driving rack (228) engaged with the driving gear (220), the driving gear (220) being configured to drive the driving rack (228) to reciprocate in a first linear direction or a second linear direction, and the driving rack (228) being connected to the door lock slider (112), so as to further cause the door lock slider (112) to move.

17. The door lock device of claim 16,
wherein the control device (160) is configured to control a rotation direction of the driving gear (220),
wherein the driving rack (228) drives the door lock slider (112) to move in the first linear direction such that the door lock slider (112) is in the retracted position when the control device (160) controls the driving gear (220) to rotate in the first direction of rotation; and
wherein the control device (160) controls the driving gear (220) to rotate in the second direction of rotation such that the door lock slider (112) is capable of moving to the extended position in the second linear direction when the obstacle detection component (445, 446, 150) detects that there is an obstacle in a gap (111) with which the door (106) is opened.

18. The door lock device of claim 17, wherein the door lock assembly (204) further comprises:
a biasing device (232) configured such that the door lock slider (112) causes the biasing device (232) to store a biasing force when the door lock slider (112) moves in the first linear direction; and
wherein the biasing force stored in the biasing device (232) is capable of driving the door lock slider (112) to move from the retracted position to the extended position in the second linear direction when the driving gear (220) rotates in the second direction of rotation.

19. The door lock device of claim 18,
wherein the control device (160) controls the driving gear (220) to rotate in the second direction of rotation such that and the door lock slider (112) moves from the retracted position to the extended position when the door (106) is controlled to move from the closed position to the one or more intermediate positions;
wherein the control device (160) controls the driving gear (220) to rotate in the first direction of rotation such that the door lock slider (112) moves from the extended position to the retracted position when the door (106) is controlled to move from the one or more intermediate positions to the closed position;
wherein the control device (160) does not control the driving gear (220) to rotate and the door lock slider (112) remains in the retracted position when the door (106) is manually moved from the closed position to the open position; and
wherein the control device (160) controls the driving gear (220) to rotate in the first direction of rotation such that the door lock slider (112) moves from the extended position to the retracted position when the door (106) is manually moved from the one or more intermediate positions to the open position.

20. The door lock device of claim 16, further comprising:
a flexible component (206), wherein the door lock slider (112) is connected to the driving assembly (202) by means of the flexible component (206),
wherein when the driving gear (220) rotates in the first direction of rotation, the driving rack (228) pulls the flexible component (206), thereby pulling the door lock slider (112) to move in the first linear direction, such that the door lock slider (112) moves to the retracted position; and
wherein when the door lock slider (112) is in the extended position and the door lock slider (112) is pushed toward the retracted position, the flexible component (206) is capable of insulating a push force generated by a movement of the door lock slider (112), so that the driving assembly (202) is not affected by the push force.

21. An electrical apparatus (100) having a door (106), wherein the electrical apparatus (100) is configured to open or close the door (106) by means of the control method of claim 1.

22. An electrical apparatus (100), comprising the door lock device (110) of claim 10 and a door (106).
